(19) United States
(12) Patent Application Publication
(10) Pub. No.: US 2026/0253256 A1
(43) Pub. Date: Aug. 27, 2026

(54) CONDITIONAL SELECTION OF A HIERARCHICAL VISION ENCODER

(71) Applicant: QUALCOMM Incorporated, San Diego, CA (US)

(72) Inventors: Titash RAKSHIT, Austin, TX (US); Munawar HAYAT, San Diego, CA (US)

(21) Appl. No.: 19/543,575

(22) Filed: Feb. 18, 2026

Related U.S. Application Data
(60) Provisional application No. 63/764,242, filed on Feb. 27, 2025.

(51) Int. Cl. G06T 9/00

(52) U.S. Cl. CPC G06T 9/00

(57) ABSTRACT

A device includes a memory configured to store one or more sets of encoder output data. The device also includes one or more processors coupled to the memory and configured to select, based on a user input, a hierarchical vision encoder (HVE) from a plurality of vision encoders. The one or more processors are further configured to use the HVE to process an image frame of a sequence of image frames to generate encoder output data.

### I. CROSS-REFERENCE TO RELATED APPLICATIONS

The present application claims priority from Provisional Patent Application No. 63/764,242, filed Feb. 27, 2025, and entitled “CONDITIONAL SELECTION OF A HIERARCHICAL VISION ENCODER,” which is incorporated herein by reference in its entirety.

### II. FIELD

The present disclosure is generally related to hierarchical vision encoding enabled cognitive analysis.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture image frames from a camera. The image frames can be used as input for further analysis, such as generating responses to image-related queries. A computing device typically has limited storage capacity that restricts the number of image frames that can be retained for later use. Transmitting the image frames to another device that may have more storage capacity for analysis can use significant bandwidth.

### IV. SUMMARY

According to one implementation of the present disclosure, a device includes a memory configured to store one or more sets of encoder output data. The device also includes one or more processors coupled to the memory and configured to select, based on a user input, a hierarchical vision encoder (HVE) from a plurality of vision encoders. The one or more processors are further configured to use the HVE to process an image frame of a sequence of image frames to generate encoder output data.

According to another implementation of the present disclosure, a device includes a memory configured to store one or more sets of encoder output data. The device also includes one or more processors coupled to the memory and configured to select, based on a remaining battery power, a hierarchical vision encoder (HVE) from a plurality of vision encoders. The one or more processors are further configured to use the HVE to process an image frame of a sequence of image frames to generate encoder output data.

According to another implementation of the present disclosure, a device includes a memory configured to store one or more sets of encoder output data. The device also includes one or more processors coupled to the memory and configured to select, based on a remaining storage capacity, a hierarchical vision encoder (HVE) from a plurality of vision encoders. The one or more processors are further configured to use the HVE to process an image frame of a sequence of image frames to generate encoder output data.

According to another implementation of the present disclosure, a device includes a memory configured to store one or more sets of encoder output data. The device also includes one or more processors coupled to the memory and configured to select, based on processor utilization, a hierarchical vision encoder (HVE) from a plurality of vision encoders. The one or more processors are further configured to use the HVE to process an image frame of a sequence of image frames to generate encoder output data.

According to another implementation of the present disclosure, a method includes selecting, based on a user input, a hierarchical vision encoder (HVE) from a plurality of vision encoders. The method also includes using, at the device, the HVE to process an image frame of a sequence of image frames to generate encoder output data.

According to another implementation of the present disclosure, a method includes selecting, based on a remaining battery power, a hierarchical vision encoder (HVE) from a plurality of vision encoders. The method also includes using the HVE to process an image frame of a sequence of image frames to generate encoder output data.

According to another implementation of the present disclosure, a method includes selecting, based on remaining storage capacity, a hierarchical vision encoder (HVE) from a plurality of vision encoders. The method also includes using the HVE to process an image frame of a sequence of image frames to generate encoder output data.

According to another implementation of the present disclosure, a method includes selecting, based on processor utilization, a hierarchical vision encoder (HVE) from a plurality of vision encoders. The method also includes using the HVE to process an image frame of a sequence of image frames to generate encoder output data.

According to another implementation of the present disclosure, a non-transitory computer-readable medium stores instructions that, when executed by one or more processors, cause the one or more processors to select, based on a user input, a hierarchical vision encoder (HVE) from a plurality of vision encoders. The instructions further cause the one or more processors to use the HVE to process an image frame of a sequence of image frames to generate encoder output data.

According to another implementation of the present disclosure, a non-transitory computer-readable medium stores instructions that, when executed by one or more processors, cause the one or more processors to select, based on a remaining battery power, a hierarchical vision encoder (HVE) from a plurality of vision encoders. The instructions further cause the one or more processors to use the HVE to process an image frame of a sequence of image frames to generate encoder output data.

According to another implementation of the present disclosure, a non-transitory computer-readable medium stores instructions that, when executed by one or more processors, cause the one or more processors to select, based on remaining storage capacity, a hierarchical vision encoder (HVE) from a plurality of vision encoders. The instructions further cause the one or more processors to use the HVE to process an image frame of a sequence of image frames to generate encoder output data.

According to another implementation of the present disclosure, a non-transitory computer-readable medium stores instructions that, when executed by one or more processors, cause the one or more processors to select, based on processor utilization, a hierarchical vision encoder (HVE) from a plurality of vision encoders. The instructions further cause the one or more processors to use the HVE to process an image frame of a sequence of image frames to generate encoder output data.

According to another implementation of the present disclosure, an apparatus includes means for selecting, based on a user input, a hierarchical vision encoder (HVE) from a plurality of vision encoders. The apparatus further includes means for using the HVE to process an image frame of a sequence of image frames to generate encoder output data.

According to another implementation of the present disclosure, an apparatus includes means for selecting, based on a remaining battery power, a hierarchical vision encoder (HVE) from a plurality of vision encoders. The apparatus further includes means for using the HVE to process an image frame of a sequence of image frames to generate encoder output data.

According to another implementation of the present disclosure, an apparatus includes means for selecting, based on remaining storage capacity, a hierarchical vision encoder (HVE) from a plurality of vision encoders. The apparatus further includes means for using the HVE to process an image frame of a sequence of image frames to generate encoder output data.

According to another implementation of the present disclosure, an apparatus includes means for selecting, based on processor utilization, a hierarchical vision encoder (HVE) from a plurality of vision encoders. The apparatus further includes means for using the HVE to process an image frame of a sequence of image frames to generate encoder output data.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1A is a block diagram of a particular illustrative example of a system operable to perform conditional selection of a hierarchical vision encoder, in accordance with some examples of the present disclosure.

FIG. 1B is a diagram of an illustrative example of a hierarchical vision encoder, in accordance with some examples of the present disclosure.

FIG. 2 is a diagram of another illustrative example of a system operable to perform conditional selection of a hierarchical vision encoder, in accordance with some examples of the present disclosure.

FIG. 3 is a diagram of another illustrative example of a system operable to perform conditional selection of a hierarchical vision encoder, in accordance with some examples of the present disclosure.

FIG. 4 is a diagram of another illustrative example of a system operable to perform conditional selection of a hierarchical vision encoder, in accordance with some examples of the present disclosure.

FIG. 5 illustrates an example of an integrated circuit operable to perform conditional selection of a hierarchical vision encoder, in accordance with some examples of the present disclosure.

FIG. 6 is a diagram of a mobile device operable to perform conditional selection of a hierarchical vision encoder, in accordance with some examples of the present disclosure.

FIG. 7A is a diagram of a wearable electronic device operable to perform conditional selection of a hierarchical vision encoder, in accordance with some examples of the present disclosure.

FIG. 7B is a diagram of a mobile device and a wearable electronic device operable to perform conditional selection of a hierarchical vision encoder, in accordance with some examples of the present disclosure.

FIG. 8A is a diagram of a mixed reality or augmented reality glasses device operable to perform conditional selection of a hierarchical vision encoder, in accordance with examples of the present disclosure.

FIG. 8B is a diagram of a mobile device and a mixed reality or augmented reality glasses device operable to perform conditional selection of a hierarchical vision encoder, in accordance with examples of the present disclosure.

FIG. 9A is a diagram of a voice-controlled speaker system operable to perform conditional selection of a hierarchical vision encoder, in accordance with some examples of the present disclosure.

FIG. 9B is a diagram of a mobile device and a voice-controlled speaker system operable to perform conditional selection of a hierarchical vision encoder, in accordance with some examples of the present disclosure.

FIG. 10A is a diagram of a camera operable to perform conditional selection of a hierarchical vision encoder, in accordance with some examples of the present disclosure.

FIG. 10B is a diagram of a mobile device and a camera operable to perform conditional selection of a hierarchical vision encoder, in accordance with some examples of the present disclosure.

FIG. 11A is a diagram of a headset, such as a virtual reality, mixed reality, or augmented reality headset, operable to perform conditional selection of a hierarchical vision encoder, in accordance with some examples of the present disclosure.

FIG. 11B is a diagram of a mobile device and a headset, such as a virtual reality, mixed reality, or augmented reality headset, operable to perform conditional selection of a hierarchical vision encoder, in accordance with some examples of the present disclosure.

FIG. 12A is a diagram of a first example of a vehicle operable to perform conditional selection of a hierarchical vision encoder, in accordance with some examples of the present disclosure.

FIG. 12A is a diagram of a mobile device and the first example of a vehicle operable to perform conditional selection of a hierarchical vision encoder, in accordance with some examples of the present disclosure.

FIG. 13A is a diagram of a second example of a vehicle operable to perform conditional selection of a hierarchical vision encoder, in accordance with some examples of the present disclosure.

FIG. 13B is a diagram of a mobile device and the second example of a vehicle operable to perform conditional selection of a hierarchical vision encoder, in accordance with some examples of the present disclosure.

FIG. 14 is a diagram of a particular implementation of a method of conditional selection of a hierarchical vision encoder that may be performed by the device of FIG. 1A, in accordance with some examples of the present disclosure.

FIG. 15 is a diagram of a particular implementation of another method of conditional selection of a hierarchical vision encoder that may be performed by the device of FIG. 2, in accordance with some examples of the present disclosure.

FIG. 16 is a diagram of a particular implementation of another method of conditional selection of a hierarchical vision encoder that may be performed by the device of FIG. 3, in accordance with some examples of the present disclosure.

FIG. 17 is a diagram of a particular implementation of another method of conditional selection of a hierarchical vision encoder that may be performed by the device of FIG. 4, in accordance with some examples of the present disclosure.

FIG. 18 is a block diagram of a particular illustrative example of a device that is operable to perform conditional selection of a hierarchical vision encoder, in accordance with some examples of the present disclosure.

### VI. DETAILED DESCRIPTION

Limited storage capacity at a device can restrict the number of image frames that can be stored and made available for further analysis. Transmitting the image frames to another device that may have more storage capacity for analysis can use significant bandwidth.

Systems and methods of conditional selection of a hierarchical vision encoder are disclosed. In an example, a hierarchical vision encoder (HVE) processes an image frame to generate encoder output data that represents the image frame. To illustrate, using a first stage of the HVE, an image frame is processed to generate first image latent data that corresponds to a first downscaled representation of the image frame. A second stage of the HVE processes the first image latent data to generate second image latent data that corresponds to a second downscaled representation of the image frame. For example, the second downscaled representation corresponds to additional downscaling of the first downscaled representation. Each subsequent stage of the HVE processes previous image latent data generated by a prior stage of the HVE to generate image latent data that corresponds to an additionally downscaled representation of the image frame. The HVE outputs image latent data generated by one or more stages as encoder output data. In an example, the HVE includes a convolutional neural network (CNN) and each stage of the HVE corresponds to a respective convolutional layer of the CNN.

The encoder output data is stored in a local memory, transmitted to another device, or both. In some examples, when cognitive analysis based on the image frame is to be performed, the encoder output data representing the image frame is retrieved from the memory and processed to generate a response to an image-related query.

The encoder output data typically has a smaller size than the original image frame. For example, fewer bits are used to store the encoder output data in the memory than bits that would be used to store the original image frame. Therefore, the encoder output data corresponding to a greater number of image frames can be stored in the memory more efficiently than storing the image frames themselves. Consequently, data from a greater number of image frames becomes accessible for cognitive analysis.

An encoder controller can have access to multiple vision encoders, such as a first HVE, a second HVE, one or more additional vision encoders, or a combination thereof. The vision encoders can be associated with respective resource usage. For example, the first HVE includes fewer parameters than the second HVE. The first HVE is associated with lower resource usage than the second HVE, whereas the second HVE is associated with richer visual representation than the first HVE. The encoder controller, based on determining that a selection criterion is satisfied, selects the corresponding HVE and uses the selected HVE to process an image frame to generate encoder output data. For example, the encoder controller, based on determining that remaining battery power is lower than a threshold, selects the first HVE corresponding to a lower resource usage. Alternatively, the encoder controller, based on determining that the remaining battery power is greater than or equal to the threshold, selects the second HVE corresponding to the richer visual representation. The encoder controller can thus dynamically balance resource usage with quality of visual representation based on various criteria, such as user input, remaining battery power, remaining storage capacity, processor utilization, temperature, etc.

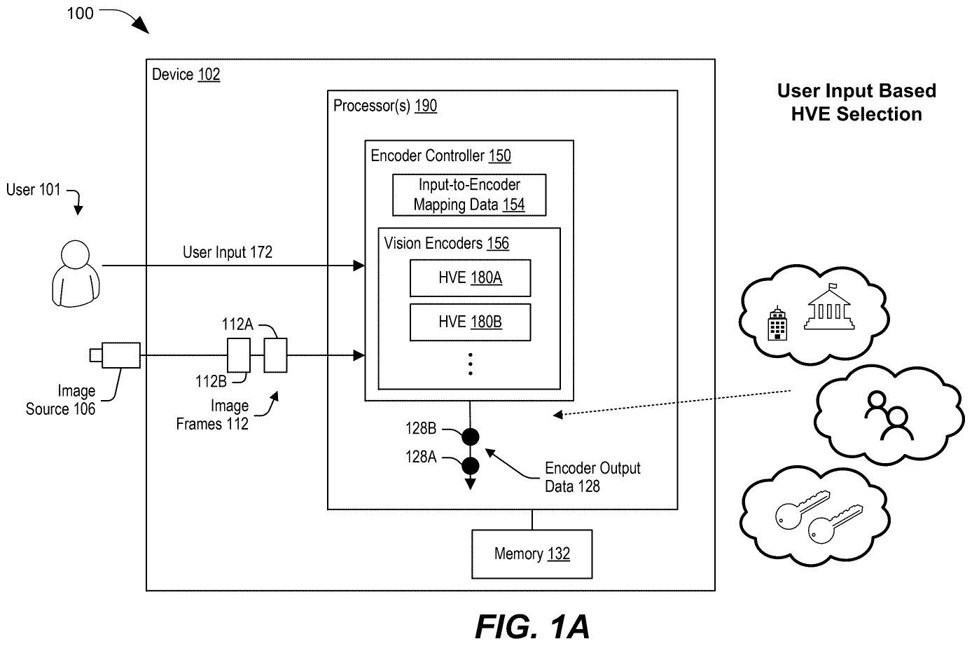

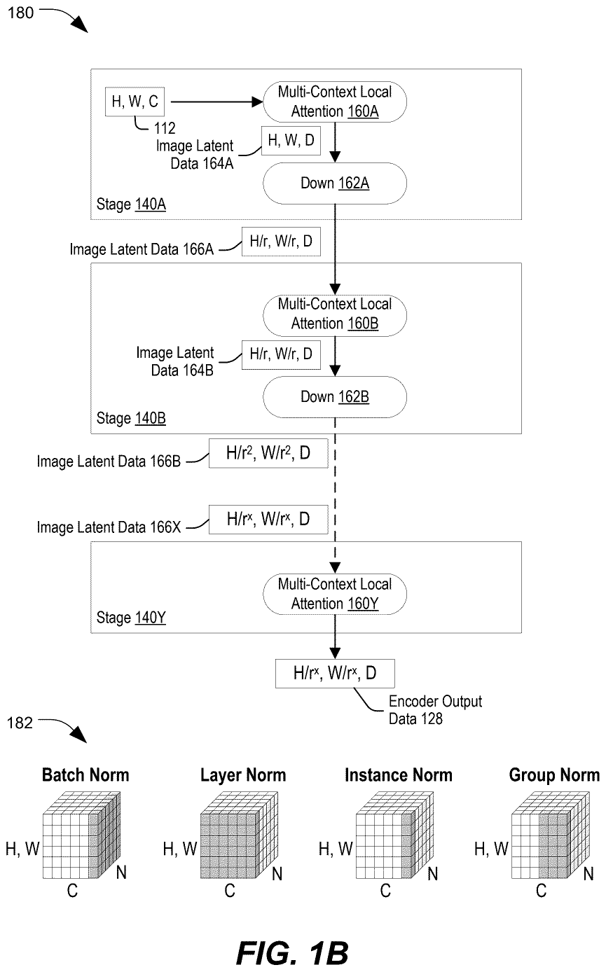

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple image frames are illustrated and associated with reference numbers 112A and 112B. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “latent data” should be understood in accordance with any of its usual and customary meanings in the fields of computer science, data science, and/or machine learning. For example, latent data can be generated by a machine-learning model as a representation of data input to the machine-learning model. Generally, the latent data include values representing underlying patterns, structures, or features that the machine-learning model infers from the input data. Ideally, the latent data represents the input data in a manner that includes important and/or unique characteristics of the input data in view of a goal or purpose of the machine-learning model. To illustrate, image latent data described herein includes latent data representing characteristics of one or more images in a manner that is useful for image-based cognitive analysis.

As used herein, the term “hierarchical vision encoder” should be understood in accordance with any of its usual and customary meanings in the fields of computer science, data science, and/or machine learning. Generally, a hierarchical vision encoder corresponds to an encoder that includes at least two stages and is configured to process image data in a hierarchical manner (e.g., output of one stage is provided as input, possibly along with other data, to a subsequent stage). To illustrate, a hierarchical vision encoder described herein includes at least a first stage and a second stage. The first stage is configured to process image data of an image frame to generate first stage output (e.g., first image latent data) corresponding to a representation (e.g., a downscaled representation) of the image frame. The second stage is configured to process the first stage output (e.g., the first image latent data) to generate second stage output (e.g., second image latent data) corresponding to a representation (e.g., an additionally downscaled representation) of the image frame. The hierarchical vision encoder is configured to generate encoder output data that is based on output of one or more of the stages.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform conditional selection of a hierarchical vision encoder is disclosed and generally designated 100. The system 100 includes a device 102 that includes one or more processors 190 coupled to a memory 132. The one or more processors 190 are also coupled to an image source 106. The one or more processors 190 include an encoder controller 150 that has access to a plurality of vision encoders 156, such as a hierarchical vision encoder (HVE) 180A, an HVE 180B, one or more additional HVEs 180, one or more other types of vision encoders, or a combination thereof. The vision encoders 156 are coupled to the memory 132.

The image source 106 is depicted as a video camera external to the device 102 as an illustrative example, in some other examples, the image source 106 can be integrated into the device 102. In some examples, the image source 106 can include various types of image sources, such as a still camera, a synthetic image generation device (e.g., a graphical processing unit (GPU)), a network device, a storage device, a communication device, or a combination thereof. The image source 106 is configured to provide a sequence of image frames 112 to the one or more processors 190. In a particular aspect, the sequence of image frames 112 includes an image frame 112A, an image frame 112B, one or more additional image frames, or a combination thereof.

The encoder controller 150 is configured to select, based on a user input, a vision encoder from a plurality of vision encoders 156. In some aspects, the encoder controller 150 has access to input-to-encoder mapping data 154 that maps user inputs to corresponding vision encoders 156 and the encoder controller 150 is configured to use the input-to-encoder mapping data 154 to select a vision encoder that corresponds to a user input. In a particular aspect, the input-to-encoder mapping data 154 is based on default data, a configuration setting, a user input, or a combination thereof.

An HVE 180 is configured to process an image frame 112 to generate encoder output data 128. In some aspects, the encoder output data 128 corresponds to a downscaled representation of the image frame 112, as further described with reference to FIG. 1B. In an example, the HVE 180 includes a plurality of stages 140. An initial stage 140 is configured to process an image frame 112 to generate first image latent data corresponding to a downscaled representation of the image frame 112. Each subsequent stage 140 is configured to process previous image latent data generated by a prior stage 140 to generate subsequent image latent data. The previous image latent data corresponds to a representation of a previous image frame (e.g., a downscaled version of the image frame 112) and the subsequent image latent data corresponds to a downscaled representation of the previous image frame (e.g., an additionally downscaled version of the image frame 112). A last stage 140 is configured to process image latent data generated by a prior stage 140 to generate the encoder output data 128. Optionally, in some embodiments, an HVE 180 includes a convolutional neural network (CNN), and a particular convolutional layer of the CNN corresponds to a respective stage 140 of the HVE 180. The encoder output data 128 represents the image frames 112. In some examples, an image frame 112 can depict sensitive information, people, homes, offices, etc., and storing or transmitting the encoder output data 128 instead of the image frames 112 enhances security.

The memory 132 is configured to store data used or generated by one or more components of the device 102. For example, the memory 132 is configured to store one or more of an image frame 112, image latent data corresponding to a representation (e.g., a downscaled representation) of the image frame 112, encoder output data 128, or additional data. In some aspects, the memory 132 includes an image buffer, an encoder output buffer, a data transmission buffer, a data receipt buffer, or a combination thereof.

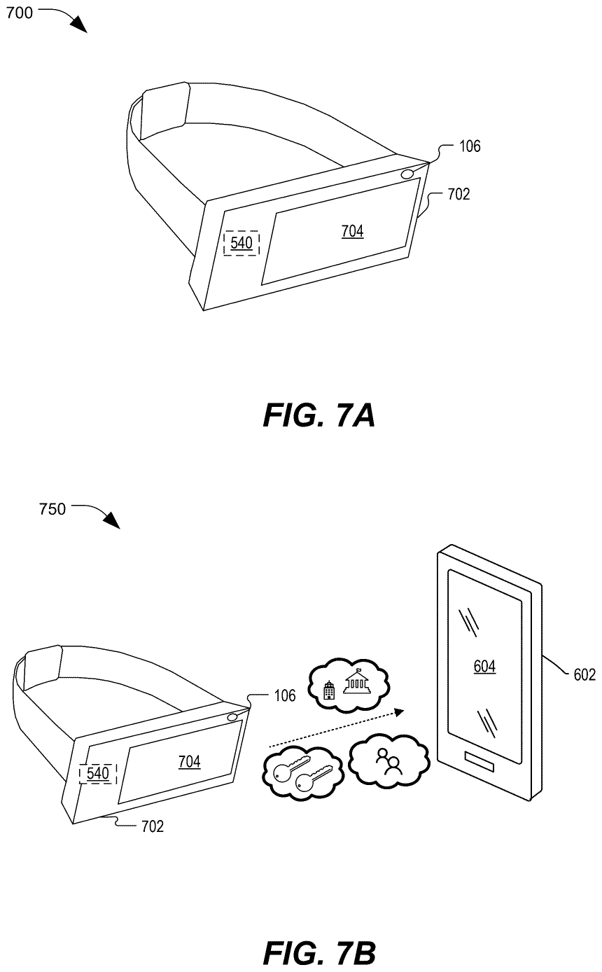

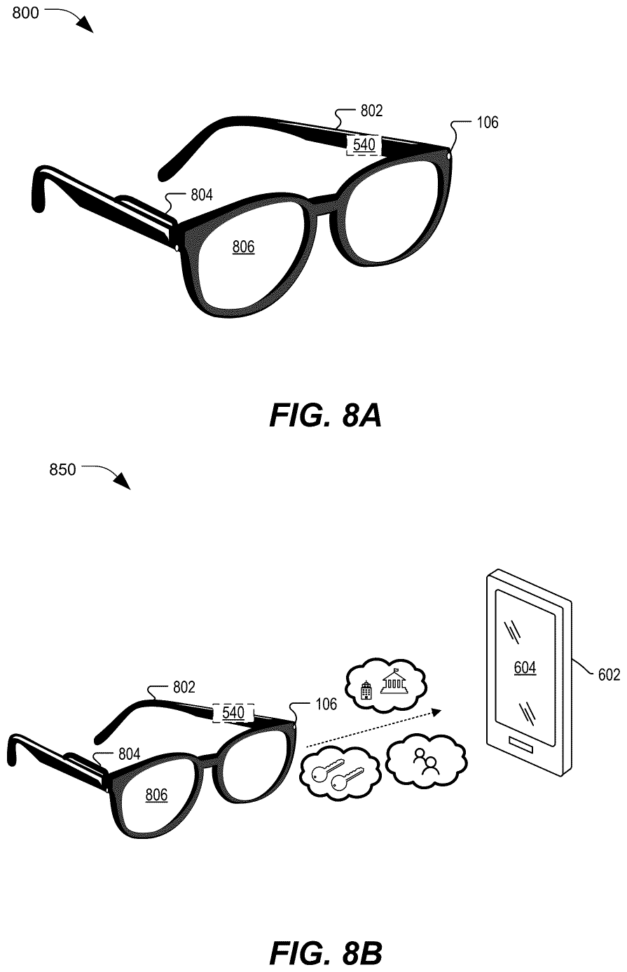

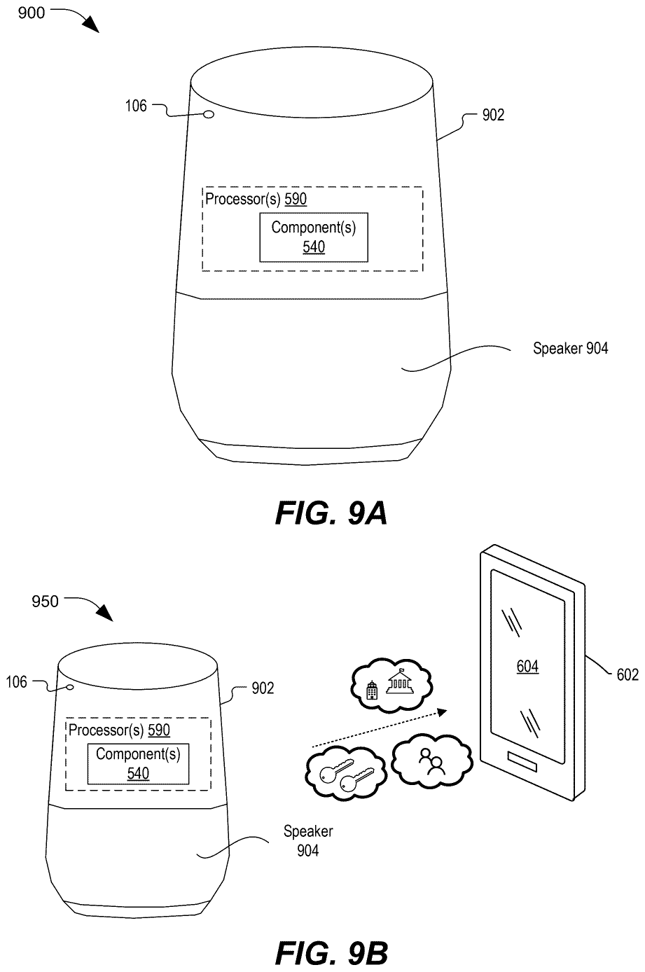

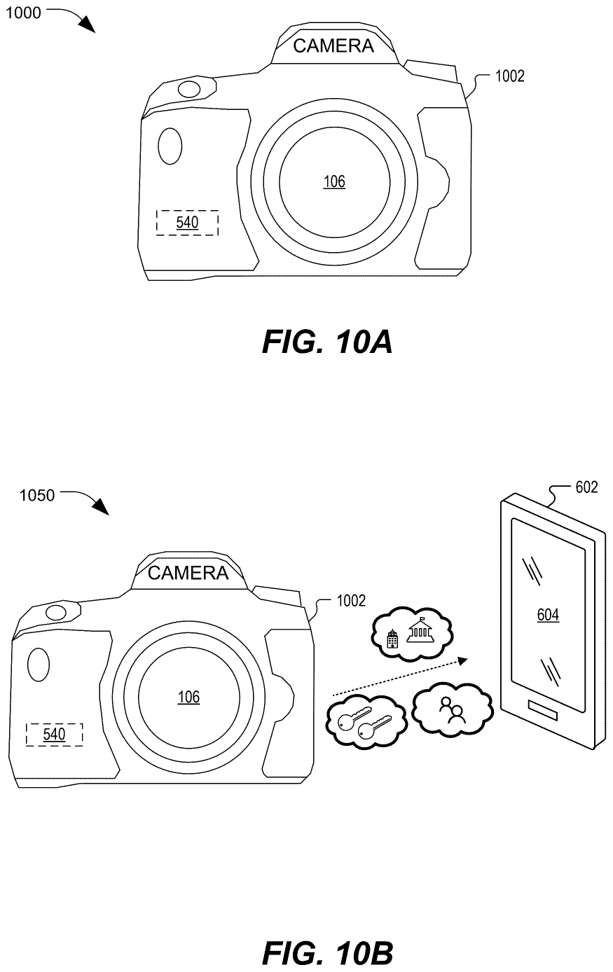

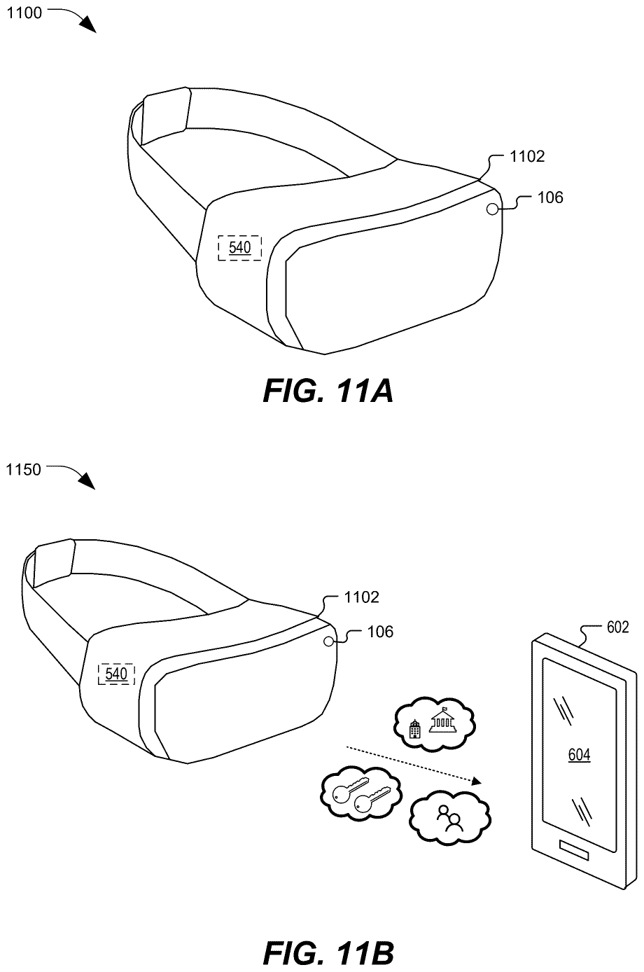

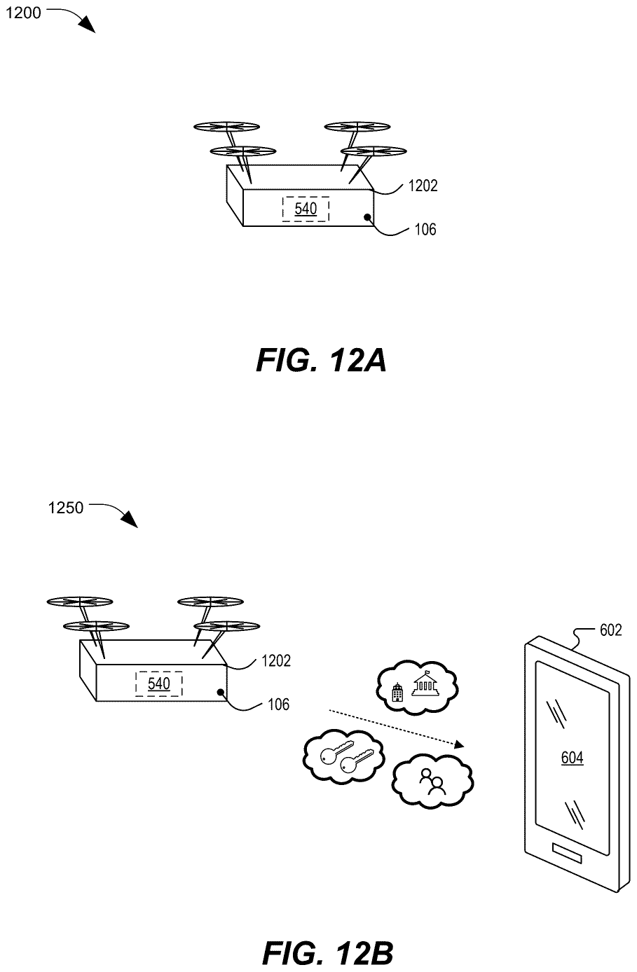

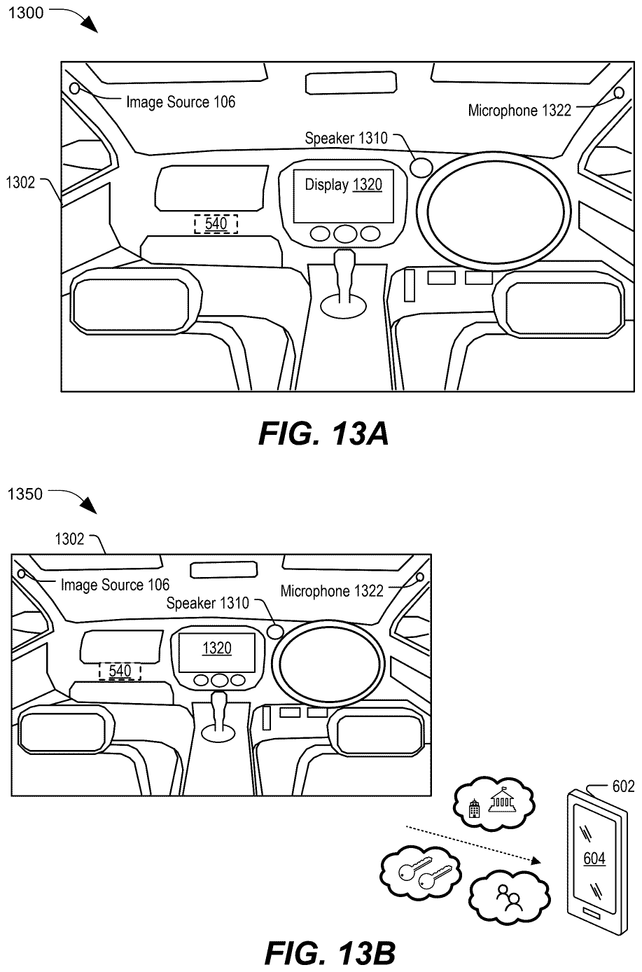

In some embodiments, the device 102 corresponds to or is included in one of various types of devices. In an illustrative example, the one or more processors 190 are integrated in at least one of a mobile phone or a tablet computer device, as described with reference to FIG. 6, a wearable electronic device, as described with reference to FIG. 7A, a mixed reality or augmented reality glasses device, as described with reference to FIG. 8A, a voice-controlled speaker system, as described with reference to FIG. 9A, a camera device, as described with reference to FIG. 10A, or a virtual reality, mixed reality, or augmented reality headset, as described with reference to FIG. 11A. In another illustrative example, the one or more processors 190 are integrated into a vehicle, such as described further with reference to FIG. 12A and FIG. 13A.

During operation, the image source 106 (e.g., a phone camera) of a user 101 provides an image frame 112A of a sequence of image frames 112 to the encoder controller 150. The encoder controller 150 selects, based on receiving a user input 172 from the user 101, a vision encoder from the vision encoders 156. For example, the encoder controller 150, in response to determining that the input-to-encoder mapping data 154 indicates that the user input 172 maps to a first vision encoder (e.g., the HVE 180A) of the vision encoders 156, selects the first vision encoder from the vision encoders 156. The encoder controller 150 provides one or more of the image frames 112 to the selected vision encoder (e.g., the HVE 180A) and the selected vision encoder processes the one or more image frames 112 to generate corresponding sets of encoder output data 128. For example, the encoder controller 150 provides the image frame 112A to the HVE 180A (e.g., the selected vision encoder), and the HVE 180A processes the image frame 112A to generate encoder output data 128A.

In some examples, the encoder output data 128A corresponds to a representation (e.g., a downscaled representation) of the image frame 112A. In some aspects, the encoder output data 128A includes a plurality of image feature embeddings that correspond to the downscaled representation of the image frame 112A. Optionally, in some embodiments, the encoder controller 150, subsequent to the selected vision encoder (e.g., the HVE 180A) processing the image frame 112A to generate the encoder output data 128A, discards the image frame 112A. To illustrate, the image frame 112A is stored in the memory 132 (e.g., an image buffer) and the encoder controller 150 marks the image frame 112A for deletion from the memory 132.

The encoder controller 150 stores the encoder output data 128A to the memory 132, initiates transmission of the encoder output data 128A to another device, or both. In an example, the encoder output data 128A is designated as associated with image-related data of the image frame 112A, such as a timestamp of the image frame 112A, a location of the image source 106 when the image frame 112A is captured, a user identifier of a user 101 that is logged into the device 102 when the image frame 112A is obtained, or a combination thereof. In some examples, the encoder output data 128A is designated as associated with the user input 172, the selected vision encoder (e.g., the HVE 180A), or both.

In some aspects, the encoder controller 150 performs similar operations to process additional image frames of the sequence of image frames 112 to generate corresponding sets of encoder output data 128. For example, the encoder controller 150, based on obtaining the image frame 112B from the image source 106 and determining that the HVE 180A remains the selected vision encoder, provides the image frame 112B to the HVE 180A. Alternatively, the encoder controller 150, based on receiving the user input 172 (e.g., a second user input) and determining that the input-to-encoder mapping data 154 indicates that the user input 172 maps to the HVE 180B, provides the image frame 112B to the HVE 180B. The selected HVE (e.g., the HVE 180A or the HVE 180B) processes the image frame 112B to generate encoder output data 128B. Optionally, in some embodiments, the encoder controller 150, subsequent to the selected HVE processing the image frame 112B to generate the encoder output data 128B, discards the image frame 112B.

Optionally, in some embodiments, the encoder controller 150 selectively processes the image frame 112B to generate the encoder output data 128B. For example, the encoder controller 150, based on a comparison of the image frame 112A and the image frame 112B, determines whether to process the image frame 112B. To illustrate, the encoder controller 150, based on determining that differences between the image frame 112A and the image frame 112B fail to satisfy a difference threshold, refrains from processing the image frame 112B and discards the image frame 112B. Alternatively, the encoder controller 150, based on determining that the differences between the image frame 112A and the image frame 112B satisfy the difference threshold, identifies a selected vision encoder from the vision encoders 156 and uses the selected vision encoder to process the image frame 112B to generate the encoder output data 128B. The encoder controller 150 stores the encoder output data 128B to the memory 132, initiates transmission of the encoder output data 128B to another device, or both. In some examples, the encoder output data 128B is designated as associated with the user input 172, the selected vision encoder (e.g., the HVE 180A or the HVE 180B), or a combination thereof.

In some examples, the HVE 180A corresponds to a first count of parameters (e.g., 35 million parameters of a neural network of a stage of the HVE 180A), the HVE 180B corresponds to a second count of parameters (e.g., 110 million parameters of a neural network of a stage of the HVE 180B), a third HVE 180 corresponds to a third count of parameters (e.g., 700 million parameters of the neural network of a stage of the third HVE 180), and so on. In a particular aspect, a lower count of parameters corresponds to lower resource usage (e.g., less memory usage, fewer computations, faster encoding, or a combination thereof), whereas a higher count of parameters corresponds to richer visual representations in the image latent data generated as the stage output.

In some examples, a first user input corresponds to a first target resource usage (e.g., low resource usage), such as indicating a user preference to conserve battery or computational resources. In some examples, a second user input corresponds to a second target resource usage (e.g., medium resource usage), such as indicating a user preference to balance resource conservation with visual representation quality. In some examples, a third user input corresponds to a third target resource usage (e.g., high resource usage), such as indicating a user preference for richer visual representation.

The input-to-encoder mapping data 154 indicates that the first target resource usage (e.g., low resource usage target), the second target resource usage (e.g., medium resource usage target), and the third target resource usage (e.g., high resource usage target) map to the first HVE 180A (e.g., fewer parameters), the second HVE 180B (e.g., medium parameters), and the third HVE 180 (e.g., more parameters), respectively. The encoder controller 150 can select the HVE 180 that is indicated by the input-to-encoder mapping data 154 as corresponding to the resource usage target indicated by the user input 172. The input-to-encoder mapping data 154 mapping three sets of target resource usage (or three user inputs) to three HVEs is provided as an illustrative example, in other examples the input-to-encoder mapping data 154 can map fewer than three or more than three sets of target resource usages (or user inputs) to corresponding vision encoders.

A technical advantage of the system 100 includes accessibility to data associated with more image frames 112 for analysis. For example, the encoder output data 128A is smaller than the image frame 112A. With limited storage capacity, sets of encoder output data 128 corresponding to more image frames 112 can be stored in the memory 132 than original image frames 112. Another technical advantage of the system 100 includes dynamically balancing resource usage with quality of visual representation based on user input.

In some examples, based on an output of an HVE 108, one or more of the vision encoders 156, a neural network, a machine-learning model, or a combination thereof, one or more components of a device (e.g., the device 102) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 1B, an illustrative example of the HVE 180 is disclosed, in accordance with some examples of the present disclosure. The HVE 180 includes a plurality of stages 140, such as a stage 140A, a stage 140B, one or more additional stages 140, a stage 140Y, or a combination thereof. It should be understood that the HVE 180 is depicted as including 3 stages 140 as an illustrative example; in other examples the HVE 180 can include fewer than 3 or more than 3 stages 140.

Each stage 140 of the HVE 180 includes a multi-context local attention 160. For example, the stage 140A includes a multi-context local attention 160A, the stage 140B includes a multi-context local attention 160B, the stage 140Y includes a multi-context local attention 160Y, and so on. One or more of the stages 140 of the HVE 180 include a downscaling layer 162 (e.g., a pooling layer or a convolution layer). For example, the stage 140A includes a downscaling layer 162A, the stage 140B includes a downscaling layer 162B, and so on. In some embodiments, the last stage (e.g., the stage 140Y) does not include a downscaling layer 162.

The multi-context local attention 160A processes data representing an image frame 112 to generate image latent data 164A. In an example, a multi-context local attention 160 is configured to capture dependencies across different parts of an input. To illustrate, the multi-context local attention 160 performs feature extraction by integrating contextual information to generate image latent data 164.

The image frame 112 has a height (H), a width (W), and channels (C). The image latent data 164A includes first image feature embeddings representing the image frame 112 having the height (H) and the width (W). An image feature embedding has an embedding dimension (D) that indicates a count of features (e.g., numerical values) represented in the image feature embedding.

The downscaling layer 162A processes the image latent data 164A to generate image latent data 166A. The image latent data 166A includes second image feature embeddings that represent a downscaled representation of the image frame 112. For example, the downscaled representation has a height (H/r) and a width (W/r), where r corresponds to a downscaling factor. In some embodiments, a second image feature embedding of image latent data 166 has the same dimensionality (D) as a first image feature embedding of image latent data 164. In some embodiments, a count of the second image feature embeddings included in the image latent data 166 that is output by a downscaling layer 162 is fewer than a count of the first image feature embeddings included in the image latent data 164 input to the downscaling layer 162.

Optionally, in some embodiments, similar operations are performed at one or more intermediate stages 140 of the HVE 180 based on output of respective previous stages 140. For example, the multi-context local attention 160B processes the image latent data 166A to generate image latent data 164B. The downscaling layer 162B processes the image latent data 164B to generate image latent data 166B. The image latent data 166B includes third image feature embeddings that represent a downscaled representation of the image frame 112. For example, the downscaled representation has a height (H/r²) and a width (W/r²), where each of the downscaling layers 162A and 162B have the same downscaling factor (r). To illustrate, the third image feature embeddings of the image latent data 166B correspond to a downscaled representation of an image frame represented by the second image frame embeddings of the image latent data 166A. In some embodiments, a count of the third image feature embeddings included in the image latent data 166B that is output by the downscaling layer 162B is fewer than a count of the second image feature embeddings included in the image latent data 166A that is output by the downscaling layer 162A.

At the stage 140Y (e.g., a last stage of the stages 140), the multi-context local attention 160B processes the image latent data 166X (e.g., image latent data 166 generated by a previous stage 140) to generate the encoder output data 128. The image latent data 122 corresponds to a downscaled representation of the image frame 112. In some aspects, the downscaled representation has a height (H/r^{x}) and a width (W/r^{x}), where x is a count of stages prior to the stage 140Y. In an example, the image latent data 122 includes fourth image feature embeddings, and each image feature embedding has an embedding dimension (D). In some aspects, a count of the fourth image feature embeddings of the image latent data 122 is fewer than a count of the first image feature embeddings of the image latent data 164A. For example, the fourth image feature embeddings correspond to a downscaled representation (e.g., an image frame having a height (H/r^{x}) and a width (W/r^{x})) as compared to the first image frame embeddings corresponding to the image frame 112 (e.g., having a height (H) and a width (W)).

It should be understood that a stage 140 can include one or more additional layers or components that are not shown, such as one or more of a normalization layer, a convolution layer, a pooling layer, etc. In an example 182, various types of normalizations are depicted, such as batch normalization, layer normalization, instance normalization, and group normalization. Height (H) and width (W) correspond to spatial dimensions of an image frame 112, C corresponds to channels in the image frame 112, and N corresponds to a batch size.

A technical advantage of the HVE 180 includes retaining characteristics of the image frames 112 in the encoder output data 128 with a reduced size, as compared to the original image frame 112 and also as compared to the image latent data 164A. The smaller size of the encoder output data 128 enables conservation of resources (e.g., memory, bandwidth, or both).

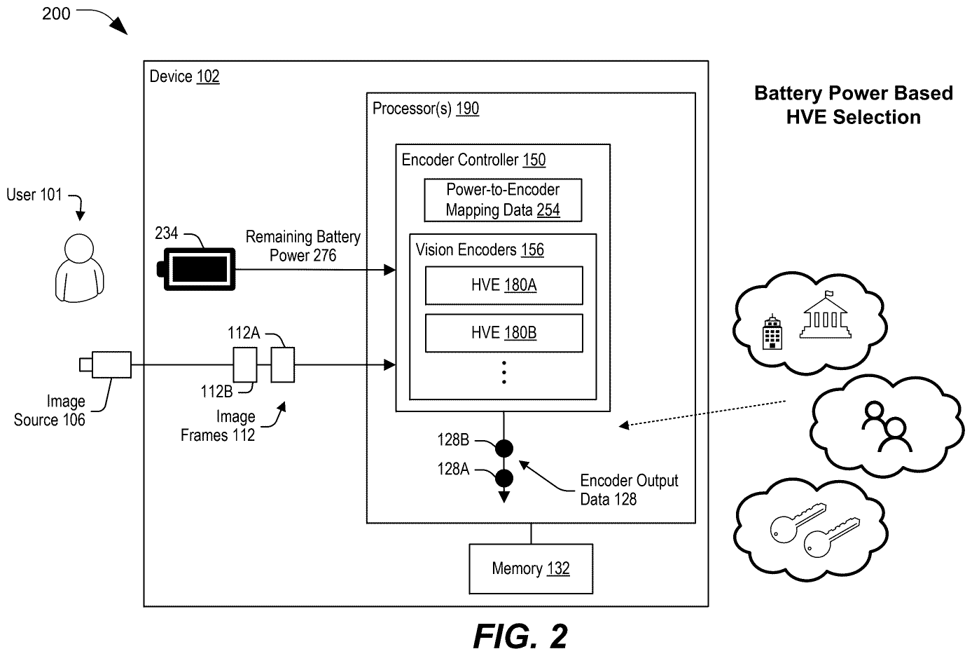

Referring to FIG. 2, a particular illustrative aspect of a system configured to perform conditional selection of a hierarchical vision encoder is disclosed and generally designated 200, in accordance with some examples of the present disclosure.

The encoder controller 150 is configured to select, based on remaining battery power, a vision encoder from a plurality of vision encoders 156. In some aspects, the encoder controller 150 has access to power-to-encoder mapping data 254 that maps battery power levels to corresponding vision encoders 156 and the encoder controller 150 is configured to use the power-to-encoder mapping data 254 to select a vision encoder that corresponds to a remaining battery power. In a particular aspect, the power-to-encoder mapping data 254 is based on default data, a configuration setting, a user input, or a combination thereof.

During operation, the image source 106 (e.g., a phone camera) of a user 101 provides an image frame 112A of a sequence of image frames 112 to the encoder controller 150. The encoder controller 150 selects, based on detecting a remaining battery power 276 of a battery of the device 102, a vision encoder from the vision encoders 156. For example, the encoder controller 150, in response to determining that the power-to-encoder mapping data 254 indicates that the remaining battery power 276 maps to a first vision encoder (e.g., the HVE 180A) of the vision encoders 156, selects the first vision encoder from the vision encoders 156. The encoder controller 150 provides one or more of the image frames 112 to the selected vision encoder (e.g., the HVE 180A) and the selected vision encoder processes the one or more image frames 112 to generate corresponding sets of encoder output data 128. For example, the encoder controller 150 provides the image frame 112A to the HVE 180A (e.g., the selected vision encoder), and the HVE 180A processes the image frame 112A to generate encoder output data 128A. The encoder controller 150 stores the encoder output data 128A to the memory 132, initiates transmission of the encoder output data 128A to another device, or both. In some examples, the encoder output data 128A is designated as associated with the remaining battery power 276, the selected vision encoder (e.g., the HVE 180A), or both.

In some aspects, the encoder controller 150 performs similar operations to process additional image frames of the sequence of image frames 112 to generate corresponding sets of encoder output data 128. For example, the encoder controller 150, based on obtaining the image frame 112B from the image source 106 and determining that the HVE 180A remains the selected vision encoder, provides the image frame 112B to the HVE 180A. Alternatively, the encoder controller 150, based on detecting the remaining battery power 276 (e.g., a second battery power level) and determining that the power-to-encoder mapping data 254 indicates that the remaining battery power 276 maps to the HVE 180B, provides the image frame 112B to the HVE 180B. The selected HVE (e.g., the HVE 180A or the HVE 180B) processes the image frame 112B to generate encoder output data 128B. The encoder controller 150 stores the encoder output data 128B to the memory 132, initiates transmission of the encoder output data 128B to another device, or both. In some examples, the encoder output data 128B is designated as associated with the remaining battery power 276, the selected vision encoder (e.g., the HVE 180A or the HVE 180B), or a combination thereof.

In some examples, a first battery power level corresponds to a first target resource usage (e.g., low resource usage), such as indicating a preference to conserve battery. In some examples, a second battery power level corresponds to a second target resource usage (e.g., medium resource usage), such as indicating a preference to balance battery conservation with visual representation quality. In some examples, a third battery power level corresponds to a third target resource usage (e.g., high resource usage), such as indicating a preference for richer visual representation.

The power-to-encoder mapping data 254 indicates that the first target resource usage (e.g., low resource usage target), the second target resource usage (e.g., medium resource usage target), and the third target resource usage (e.g., high resource usage target) map to the first HVE 180A (e.g., fewer parameters), the second HVE 180B (e.g., medium parameters), and the third HVE 180 (e.g., more parameters), respectively. The encoder controller 150 can select the HVE 180 that is indicated by the power-to-encoder mapping data 254 as corresponding to the resource usage target that matches the remaining battery power 276. The power-to-encoder mapping data 254 mapping three sets of target resource usage (or three battery power levels) to three HVEs is provided as an illustrative example, in other examples the power-to-encoder mapping data 254 can map fewer than three or more than three sets of target resource usages (or battery power levels) to corresponding vision encoders.

A technical advantage of the system 200 includes accessibility to data associated with more image frames 112 for analysis. For example, the encoder output data 128A is smaller than the image frame 112A. With limited storage capacity, sets of encoder output data 128 corresponding to more image frames 112 can be stored in the memory 132 than original image frames 112. Another technical advantage of the system 200 includes dynamically balancing resource usage with quality of visual representation based on remaining battery power level.

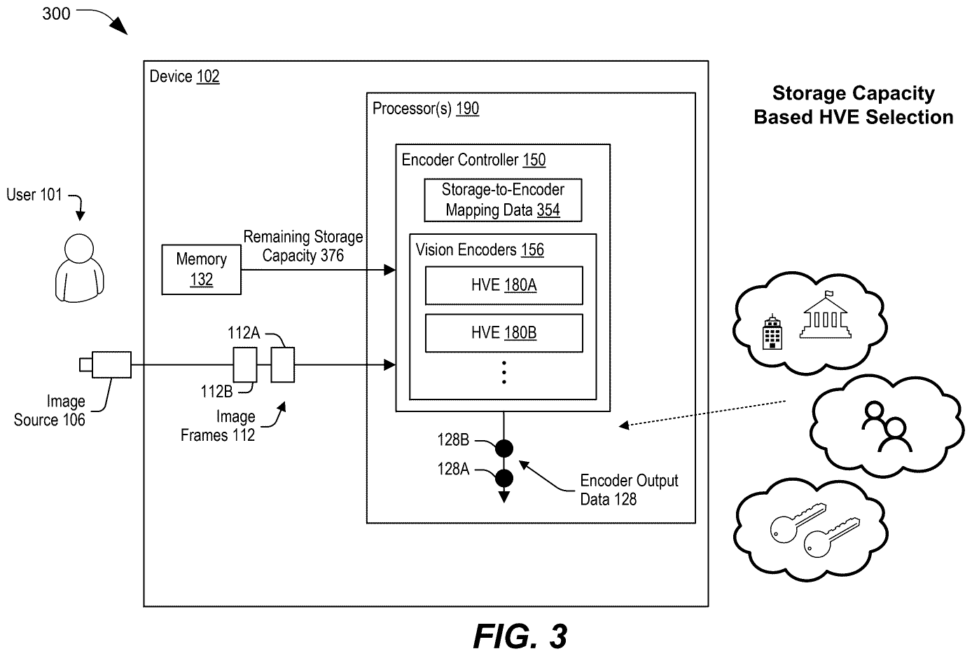

Referring to FIG. 3, a particular illustrative aspect of a system configured to perform conditional selection of a hierarchical vision encoder is disclosed and generally designated 300, in accordance with some examples of the present disclosure.

The encoder controller 150 is configured to select, based on remaining storage capacity, a vision encoder from a plurality of vision encoders 156. In some aspects, the encoder controller 150 has access to storage-to-encoder mapping data 354 that maps remaining storage capacity levels to corresponding vision encoders 156 and the encoder controller 150 is configured to use the storage-to-encoder mapping data 354 to select a vision encoder that corresponds to a remaining storage capacity. In a particular aspect, the storage-to-encoder mapping data 354 is based on default data, a configuration setting, a user input, or a combination thereof.

During operation, the image source 106 (e.g., a phone camera) of a user 101 provides an image frame 112A of a sequence of image frames 112 to the encoder controller 150. The encoder controller 150 selects, based on detecting a remaining storage capacity 376 of the memory 132, a vision encoder from the vision encoders 156. In some examples, a portion of the memory 132 is allocated for storing encoder output data and the remaining storage capacity 376 indicates an available (e.g., unused) amount of the allocated portion.

In an example, the encoder controller 150, in response to determining that the storage-to-encoder mapping data 354 indicates that the remaining storage capacity 376 maps to a first vision encoder (e.g., the HVE 180A) of the vision encoders 156, selects the first vision encoder from the vision encoders 156. The encoder controller 150 provides one or more of the image frames 112 to the selected vision encoder (e.g., the HVE 180A) and the selected vision encoder processes the one or more image frames 112 to generate corresponding sets of encoder output data 128. For example, the encoder controller 150 provides the image frame 112A to the HVE 180A (e.g., the selected vision encoder) and the HVE 180A processes the image frame 112A to generate encoder output data 128A. The encoder controller 150 stores the encoder output data 128A in the memory 132, initiates transmission of the encoder output data 128A to another device, or both. In some examples, the encoder output data 128A is designated as associated with the remaining storage capacity 376, the selected vision encoder (e.g., the HVE 180A), or both.

In some aspects, the encoder controller 150 performs similar operations to process additional image frames of the sequence of image frames 112 to generate corresponding sets of encoder output data 128. For example, the encoder controller 150, based on obtaining the image frame 112B from the image source 106 and determining that the HVE 180A remains the selected vision encoder, provides the image frame 112B to the HVE 180A. Alternatively, the encoder controller 150, based on detecting the remaining storage capacity 376 (e.g., a second storage capacity level) and determining that the storage-to-encoder mapping data 354 indicates that the remaining storage capacity 376 maps to the HVE 180B, provides the image frame 112B to the HVE 180B. In a particular aspect, the second remaining storage capacity 376 is based on first remaining storage capacity 376 (prior to storing the encoder output data 128A in the memory 132) and a size of the encoder output data 128A. The selected HVE (e.g., the HVE 180A or the HVE 180B) processes the image frame 112B to generate encoder output data 128B. The encoder controller 150 stores the encoder output data 128B in the memory 132, initiates transmission of the encoder output data 128B to another device, or both. In some examples, the encoder output data 128B is designated as associated with the remaining storage capacity 376, the selected vision encoder (e.g., the HVE 180A or the HVE 180B), or a combination thereof.

In some examples, a first storage capacity level corresponds to a first target resource usage (e.g., low resource usage), such as indicating a preference to reduce memory usage. In some examples, a second storage capacity level corresponds to a second target resource usage (e.g., medium resource usage), such as indicating a preference to balance memory usage with visual representation quality. In some examples, a third storage capacity level corresponds to a third target resource usage (e.g., high resource usage), such as indicating a preference for richer visual representation.

The storage-to-encoder mapping data 354 indicates that the first target resource usage (e.g., low resource usage target), the second target resource usage (e.g., medium resource usage target), and the third target resource usage (e.g., high resource usage target) map to the first HVE 180A (e.g., fewer parameters), the second HVE 180B (e.g., medium parameters), and the third HVE 180 (e.g., more parameters), respectively. The encoder controller 150 can select the HVE 180 that is indicated by the storage-to-encoder mapping data 354 as corresponding to the resource usage target that matches the remaining storage capacity 376. The storage-to-encoder mapping data 354 mapping three sets of target resource usage (or three storage capacity levels) to three HVEs is provided as an illustrative example, in other examples the storage-to-encoder mapping data 354 can map fewer than three or more than three sets of target resource usages (or storage capacity levels) to corresponding vision encoders.

A technical advantage of the system 300 includes accessibility to data associated with more image frames 112 for analysis. For example, the encoder output data 128A is smaller than the image frame 112A. With limited storage capacity, sets of encoder output data 128 corresponding to more image frames 112 can be stored in the memory 132 than original image frames 112. Another technical advantage of the system 300 includes dynamically balancing resource usage with quality of visual representation based on remaining storage capacity level.

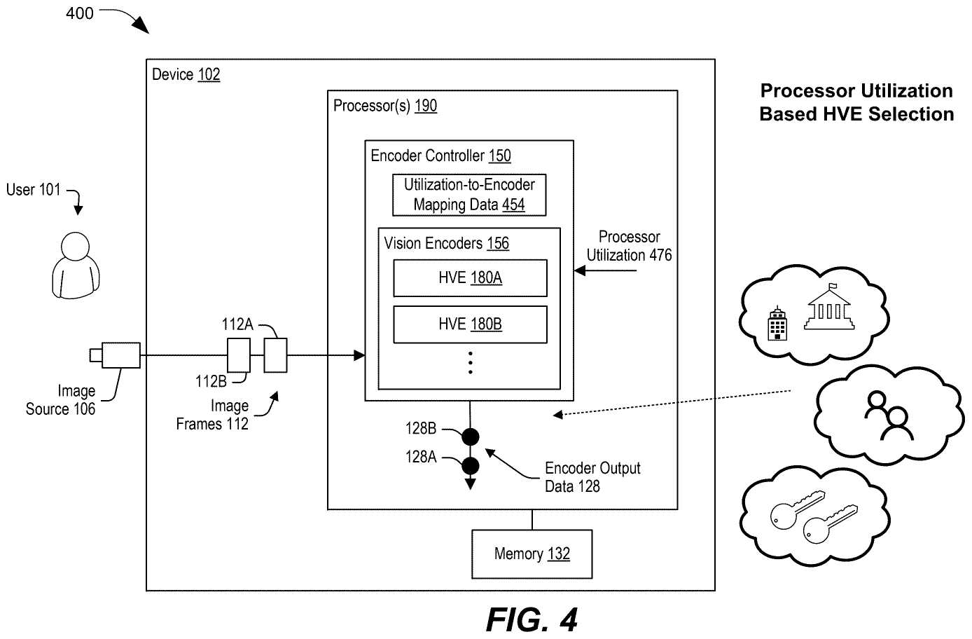

Referring to FIG. 4, a particular illustrative aspect of a system configured to perform conditional selection of a hierarchical vision encoder is disclosed and generally designated 400, in accordance with some examples of the present disclosure.

The encoder controller 150 is configured to select, based on processor utilization, a vision encoder from a plurality of vision encoders 156. In some aspects, the encoder controller 150 has access to utilization-to-encoder mapping data 454 that maps processor utilization levels to corresponding vision encoders 156 and the encoder controller 150 is configured to use the utilization-to-encoder mapping data 454 to select a vision encoder that corresponds to a detected processor utilization. In a particular aspect, the utilization-to-encoder mapping data 454 is based on default data, a configuration setting, a user input, or a combination thereof.

During operation, the image source 106 (e.g., a phone camera) of a user 101 provides an image frame 112A of a sequence of image frames 112 to the encoder controller 150. The encoder controller 150 selects, based on detecting a processor utilization 476 of one or more of the processor(s) 190, a vision encoder from the vision encoders 156. In some examples, the processor utilization 476 indicates a usage of a processor 190, user processor time (e.g., time spent executing user-space processes), system processor time (e.g., time spent on kernel-level operations), idle time (e.g., percentage of time a processor 190 is not executing any tasks), input/output wait time, load average (e.g., average number of processes waiting to execute in a given time period), a count of context switches per second, a count of processor throttling events (e.g., due to overheating or power-saving measures), or a combination thereof.

In an example, the encoder controller 150, in response to determining that the utilization-to-encoder mapping data 454 indicates that the processor utilization 476 maps to a first vision encoder (e.g., the HVE 180A) of the vision encoders 156, selects the first vision encoder from the vision encoders 156. The encoder controller 150 provides one or more of the image frames 112 to the selected vision encoder (e.g., the HVE 180A) and the selected vision encoder processes the one or more image frames 112 to generate corresponding sets of encoder output data 128. For example, the encoder controller 150 provides the image frame 112A to the HVE 180A (e.g., the selected vision encoder) and the HVE 180A processes the image frame 112A to generate encoder output data 128A. The encoder controller 150 stores the encoder output data 128A in the memory 132, initiates transmission of the encoder output data 128A to another device, or both. In some examples, the encoder output data 128A is designated as associated with the processor utilization 476, the selected vision encoder (e.g., the HVE 180A), or both.

In some aspects, the encoder controller 150 performs similar operations to process additional image frames of the sequence of image frames 112 to generate corresponding sets of encoder output data 128. For example, the encoder controller 150, based on obtaining the image frame 112B from the image source 106 and determining that the HVE 180A remains the selected vision encoder, provides the image frame 112B to the HVE 180A. Alternatively, the encoder controller 150, based on detecting the processor utilization 476 (e.g., a second processor utilization level) and determining that the utilization-to-encoder mapping data 454 indicates that the processor utilization 476 maps to the HVE 180B, provides the image frame 112B to the HVE 180B. The selected HVE (e.g., the HVE 180A or the HVE 180B) processes the image frame 112B to generate encoder output data 128B. The encoder controller 150 stores the encoder output data 128B in the memory 132, initiates transmission of the encoder output data 128B to another device, or both. In some examples, the encoder output data 128B is designated as associated with the processor utilization 476, the selected vision encoder (e.g., the HVE 180A or the HVE 180B), or a combination thereof.

In some examples, a first processor utilization level corresponds to a first target resource usage (e.g., low resource usage), such as indicating a preference to reduce processor utilization. In some examples, a second processor utilization level corresponds to a second target resource usage (e.g., medium resource usage), such as indicating a preference to balance processor utilization with visual representation quality. In some examples, a third processor utilization level corresponds to a third target resource usage (e.g., high resource usage), such as indicating a preference for richer visual representation.

The utilization-to-encoder mapping data 454 indicates that the first target resource usage (e.g., low resource usage target), the second target resource usage (e.g., medium resource usage target), and the third target resource usage (e.g., high resource usage target) map to the first HVE 180A (e.g., fewer parameters), the second HVE 180B (e.g., medium parameters), and the third HVE 180 (e.g., more parameters), respectively. The encoder controller 150 can select the HVE 180 that is indicated by the utilization-to-encoder mapping data 454 as corresponding to the resource usage target that matches the processor utilization 476. The utilization-to-encoder mapping data 454 mapping three sets of target resource usage (or three processor utilization levels) to three HVEs is provided as an illustrative example, in other examples the utilization-to-encoder mapping data 454 can map fewer than three or more than three sets of target resource usages (or processor utilization levels) to corresponding vision encoders.

A technical advantage of the system 400 includes accessibility to data associated with more image frames 112 for analysis. For example, the encoder output data 128A is smaller than the image frame 112A. With limited processor utilization, sets of encoder output data 128 corresponding to more image frames 112 can be stored in the memory 132 than original image frames 112. Another technical advantage of the system 400 includes dynamically balancing resource usage with quality of visual representation based on detected processor utilization.

It should be understood that user input, remaining battery power, remaining storage capacity, and processor utilization are provided as non-limiting illustrative factors that can be used to select a vision encoder; in other examples another factor (e.g., temperature) or some combination of factors can be used to select a vision encoder. It should be understood that mapping data is provided as an illustrative mechanism for selecting a vision encoder based on one or more factors; in other examples, the encoder controller 150 can use procedural operations, a machine-learning model, mapping data, or a combination thereof, to select a vision encoder based on one or more factors.

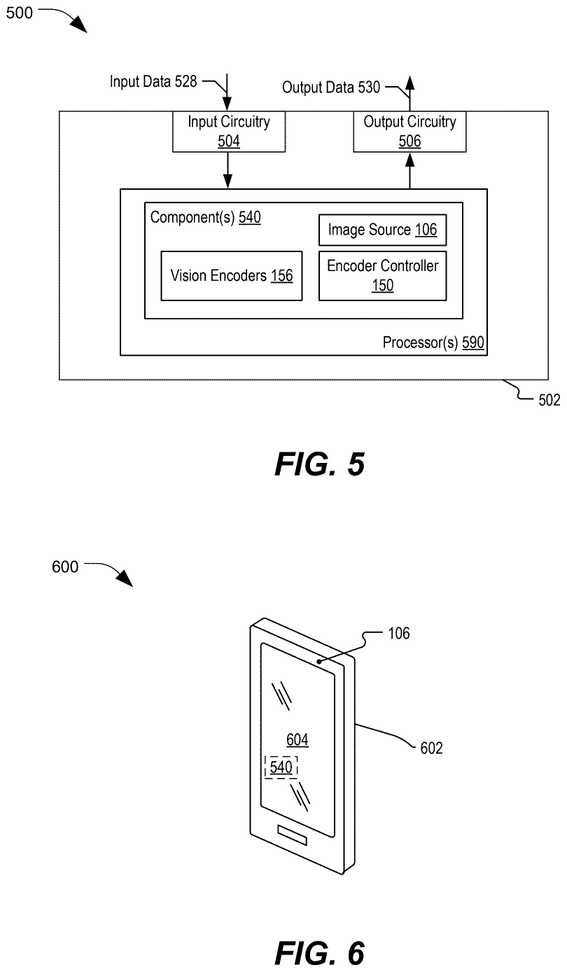

FIG. 5 depicts an implementation 500 of an integrated circuit 502 that includes one or more processors 590. In a particular aspect, the integrated circuit 502 corresponds to an implementation of the device 102.

The one or more processors 590 include one or more components 540, such as the image source 106, the encoder controller 150, the vision encoders 156, or a combination thereof.

The integrated circuit 502 also includes input circuitry 504, such as one or more bus interfaces, to enable input data 528 to be received for processing. In a particular aspect, the input data 528 includes data used by one or more of the components 540, as described herein. For example, the input data 528 includes the sequence of image frames 112, the image latent data 164, the image latent data 166, the sets of encoder output data 128, the user input 172, the remaining battery power 276 of FIG. 2, the remaining storage capacity 376 of FIG. 3, the processor utilization 476 of FIG. 4, or a combination thereof.

The integrated circuit 502 also includes output circuitry 506, such as a bus interface, to enable sending of output data 530. In a particular aspect, the output data 530 includes data generated by one or more of the components 540, as described herein. For example, the output data 530 includes the sequence of image frames 112, the image latent data 164, the image latent data 166, the sets of encoder output data 128, or a combination thereof.

The integrated circuit 502 enables implementation of conditional selection of a hierarchical vision encoder as a component in a system, such as a mobile phone or tablet as depicted in FIG. 6, a wearable electronic device as depicted in FIG. 7A, a mixed reality or augmented reality glasses device, as described with reference to FIG. 8A, a voice-controlled speaker system as depicted in FIG. 9A, a camera as depicted in FIG. 10A, a virtual reality, mixed reality, or augmented reality headset as depicted in FIG. 11A, or a vehicle as depicted in FIG. 12A or FIG. 13A.

FIG. 6 depicts an implementation 600 of a mobile device 602, such as a phone or tablet, as illustrative, non-limiting examples. In a particular aspect, the mobile device 602 corresponds to an implementation of the device 102.

The mobile device 602 includes a display screen 604, and optionally the image source 106. In some examples, the image source 106 is external to the mobile device 602 (e.g., a network device, a glasses device, a headset, an external camera, or a combination thereof). The one or more components 540 of the processor(s) 590 are integrated in the mobile device 602 and are illustrated using dashed lines to indicate internal components that are not generally visible to a user of the mobile device 602. In a particular example, a user input is detected, which is then processed to perform one or more operations at the mobile device 602, such as to launch a graphical user interface or otherwise display a notification at the display screen 604 (e.g., via an integrated “smart assistant” application).

The mobile device 602 performs one or more operations described with reference to the device 102 of FIGS. 1A-4. For example, in some aspects, the mobile device 602 obtains the image frames 112 from the image source 106 and generates the sets of encoder output data 128, as described with reference to FIGS. 1A-4. To illustrate, the mobile device 602 selects an HVE 180 based on the user input 172, the remaining battery power 276, the remaining storage capacity 376, the processor utilization 476, one or more additional factors (e.g., temperature), or a combination thereof. The mobile device 602 uses the selected HVE 180 to process an image frame 112A to generate encoder output data 128A, as described with reference to FIGS. 1-4. The mobile device 602 stores the encoder output data 128A in a memory, transmits the encoder output data 128A to another device, or both.

FIG. 7A depicts an implementation 700 of a wearable electronic device 702, illustrated as a “smart watch.” In a particular aspect, the wearable electronic device 702 corresponds to an implementation of the device 102.

The one or more components 540, and optionally the image source 106, are integrated into the wearable electronic device 702. In some examples, the image source 106 is external to the wearable electronic device 702 (e.g., a network device, a glasses device, a headset, an external camera, or a combination thereof). The wearable electronic device 702 performs one or more operations described with reference to the device 102 of FIGS. 1A-4. For example, the component(s) 540 operate to obtain the image frames 112, the sets of encoder output data 128, the user input 172, the remaining battery power 276, the remaining storage capacity 376, the processor utilization 476, a temperature, one or more additional factors, or a combination thereof, which are then processed to perform one or more operations at the wearable electronic device 702, such as to launch a graphical user interface or otherwise display other information associated with the image frames 112, the sets of encoder output data 128, the user input 172, the remaining battery power 276, the remaining storage capacity 376, the processor utilization 476, a temperature, one or more additional factors, or a combination thereof at a display screen 704 of the wearable electronic device 702.

In some aspects, the wearable electronic device 702 may include a display screen that is configured to display a notification based on obtaining the image frames 112, the sets of encoder output data 128, the user input 172, the remaining battery power 276, the remaining storage capacity 376, the processor utilization 476, a temperature, one or more additional factors, or a combination thereof. In a particular example, the wearable electronic device 702 includes a haptic device that provides a haptic notification (e.g., vibrates) in response to obtaining the image frames 112, the sets of encoder output data 128, the user input 172, the remaining battery power 276, the remaining storage capacity 376, the processor utilization 476, a temperature, one or more additional factors, or a combination thereof. For example, the haptic notification can cause a user to look at the wearable electronic device 702 to see a displayed notification indicating detection of the image frames 112, the sets of encoder output data 128, the user input 172, the remaining battery power 276, the remaining storage capacity 376, the processor utilization 476, a temperature, one or more additional factors, or a combination thereof. The wearable electronic device 702 can thus alert a user with a hearing impairment or a user wearing a headset that the image frames 112, the sets of encoder output data 128, the user input 172, the remaining battery power 276, the remaining storage capacity 376, the processor utilization 476, a temperature, one or more additional factors, the query 136, the response 138, or a combination thereof, are detected.

FIG. 7B depicts an example 750 of the mobile device 602 and the wearable electronic device 702. The wearable electronic device 702 is configured to conditionally select an HVE 180, as described with reference to FIGS. 1A-4. The wearable electronic device 702 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

It should be understood that the mobile device 602 is provided as an illustrative example of a recipient device that receives the encoder output data 128; in other examples various types of devices can be recipients of encoder output data 128. In some examples, the mobile device 602 can transmit the encoder output data 128 to various other devices.

FIG. 8A depicts an implementation 800 of a portable electronic device that corresponds to augmented reality or mixed reality glasses 802. In a particular aspect, the glasses 802 correspond to an implementation of the device 102.

The glasses 802 include a holographic projection unit 804 configured to project visual data onto a surface of a lens 806 or to reflect the visual data off of a surface of the lens 806 and onto the wearer's retina. The one or more components 540 and, optionally the image source 106, are integrated into the glasses 802. In some examples, the image source 106 is external to the glasses 802 (e.g., a network device, a glasses device, a headset, an external camera, or a combination thereof).

The glasses 802 perform one or more operations described with reference to the device 102 of FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors, or a combination thereof, as described with reference to FIGS. 1A-4.

In a particular example, the holographic projection unit 804 is configured to display a notification based on obtaining the image frames 112, the sets of encoder output data 128, the user input 172, the remaining battery power 276, the remaining storage capacity 376, the processor utilization 476, a temperature, one or more additional factors, or a combination thereof. For example, the notification can be superimposed on the user's field of view.

FIG. 8B depicts an example 850 of the mobile device 602 and the glasses 802. The glasses 802 are configured to conditionally select an HVE 180, as described with reference to FIGS. 1A-4. The glasses 802 are configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

FIG. 9A is an implementation 900 of a wireless speaker and voice activated device 902. In a particular aspect, the wireless speaker and voice activated device 902 corresponds to an implementation of the device 102.

The wireless speaker and voice activated device 902 can have wireless network connectivity and is configured to execute an assistant operation. The one or more components 540 and, optionally the image source 106, are integrated into the wireless speaker and voice activated device 902. In some examples, the image source 106 is external to the wireless speaker and voice activated device 902 (e.g., a network device, a glasses device, a headset, an external camera, or a combination thereof). The wireless speaker and voice activated device 902 also includes a speaker 904.

The wireless speaker and voice activated device 902 performs one or more operations described with reference to the device 102 of FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors, or a combination thereof, as described with reference to FIGS. 1A-4.

During operation, in response to receiving a verbal command, the wireless speaker and voice activated device 902 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In an example, the assistant operations include generating the encoder output data 128, as described with reference to FIGS. 1A-4.

FIG. 9B depicts an example 950 of the mobile device 602 and the wireless speaker and voice activated device 902. The wireless speaker and voice activated device 902 is configured to conditionally select an HVE 180, as described with reference to FIGS. 1A-4. The wireless speaker and voice activated device 902 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

FIG. 10A depicts an implementation 1000 of a portable electronic device that corresponds to a camera device 1002. In a particular aspect, the camera device 1002 corresponds to an implementation of the device 102.

The one or more components 540 and, optionally the image source 106, are included in the camera device 1002. The camera device 1002 performs one or more operations described with reference to FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors, or a combination thereof, as described with reference to FIGS. 1A-4.

During operation, in response to receiving a verbal command, the camera device 1002 can execute operations responsive to spoken user commands, such as to adjust image or video capture settings, image or video playback settings, or image or video capture instructions, as illustrative examples. In an example, the camera device 1002 generates the encoder output data 128, as described with reference to FIGS. 1A-4.

FIG. 10B depicts an example 1050 of the mobile device 602 and the camera device 1002. The camera device 1002 is configured to conditionally select an HVE 180, as described with reference to FIGS. 1A-4. The camera device 1002 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

FIG. 11A depicts an implementation 1100 of a portable electronic device that corresponds to a virtual reality, mixed reality, or augmented reality headset 1102. In a particular aspect, the headset 1102 corresponds to an implementation of the device 102.

The one or more components 540 and, optionally the image source 106, are included in the headset 1102. The headset 1102 performs one or more operations described with reference to FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors, or a combination thereof, as described with reference to FIGS. 1A-4. In some aspects, the headset 1102 obtains the sequence of image frames 112 from the image source 106, generates the sets of encoder output data 128, and sends the sets of encoder output data 128 to another device.

In an example, a visual interface device is positioned in front of the user's eyes to enable display of augmented reality, mixed reality, or virtual reality images or scenes to the user while the headset 1102 is worn. In a particular example, the visual interface device is configured to display a notification indicating that image frames 112, the sets of encoder output data 128, the user input 172, the remaining battery power 276, the remaining storage capacity 376, the processor utilization 476, a temperature, one or more additional factors, or a combination thereof, are detected.

FIG. 11B depicts an example 1150 of the mobile device 602 and the headset 1102. The headset 1102 is configured to conditionally select an HVE 180, as described with reference to FIGS. 1A-4. The headset 1102 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

FIG. 12A depicts an implementation 1200 of a vehicle 1202, illustrated as a manned or unmanned aerial device (e.g., a package delivery drone). In a particular aspect, the device 102 corresponds to or is integrated into the vehicle 1202.

The one or more components 540 and, optionally the image source 106, are included in the vehicle 1202. The vehicle 1202 performs one or more operations described with reference to FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors or a combination thereof, as described with reference to FIGS. 1A-4.

In an example, the vehicle 1202 processes the image frames 112 to generate the sets of encoder output data 128, as described with reference to FIGS. 1A-4. In some examples, the vehicle 1202 selects the HVE 180B when a remaining battery power of the vehicle 1202 is above a threshold to prioritize visual representation quality, and selects the HVE 180A when the remaining battery power of the vehicle 1202 is less than or equal to the threshold to conserve resources. In some examples, the vehicle 1202 stores the encoder output data 128 in a memory, sends the sets of encoder output data 128 to another device, or both.

FIG. 12B depicts an example 1250 of the mobile device 602 and the vehicle 1202. The vehicle 1202 is configured to conditionally select an HVE 180, as described with reference to FIGS. 1A-4. The vehicle 1202 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

FIG. 13A depicts another implementation 1300 of a vehicle 1302, illustrated as a car. In a particular aspect, the vehicle 1302 corresponds to an implementation of the device 102. In a particular aspect, the device 102 corresponds to or is integrated into the vehicle 1302.

The one or more components 540 and, optionally the image source 106, are included in the vehicle 1302. In some aspects, the vehicle 1302 includes a microphone 1322. The vehicle 1302 performs one or more operations described with reference to the device 102 of FIGS. 1A-4. For example, the component(s) 540 may function to obtain the image frames 112, the sets of encoder output data 128, the user input 172, the remaining battery power 276, the remaining storage capacity 376, the processor utilization 476, a temperature, one or more additional factors, or a combination thereof, as described with reference to FIGS. 1A-4.

In some aspects, the user input 172 may be detected based on audio signals received from the microphone 1322 of the vehicle 1302. In some implementations, user input detection can be performed based on an audio signal received from interior microphones (e.g., the microphone 1322), such as for a voice command from an authorized passenger. In some implementations, user input detection can be performed based on an audio signal received from external microphones (e.g., the microphone 1322), such as an authorized user of the vehicle. In a particular implementation, in response to receiving a verbal command, a voice activation system initiates one or more operations of the vehicle 1302 based on one or more keywords (e.g., “unlock,” “start engine,” “play music,” “display weather forecast,” or another voice command) detected in an audio signal, such as by providing feedback or information via a display 1320 or one or more speakers (e.g., a speaker 1310).

In some aspects, the vehicle 1302 processes image frames 112 to generate the sets of encoder output data 128. In some examples, the vehicle 1302 selects the HVE 180B when a remaining battery power of the vehicle 1302 is above a threshold to prioritize visual representation quality, and selects the HVE 180A when the remaining battery power of the vehicle 1302 is less than or equal to the threshold to conserve resources. In some examples, the vehicle 1302 stores the encoder output data 128 in a memory, sends the sets of encoder output data 128 to another device, or both.

FIG. 13B depicts an example 1350 of the mobile device 602 and the vehicle 1302. The vehicle 1302 is configured to conditionally select an HVE 180, as described with reference to FIGS. 1A-4. The vehicle 1302 is configured to use the HVE 180 to process an image frame 112 to generate encoder output data 128, and to transmit the encoder output data 128 to another device (e.g., the mobile device 602). In some examples, an image frame 112 can depict sensitive information, people, homes, offices, etc., and transmitting the encoder output data 128 instead of the image frames 112 enhances security.

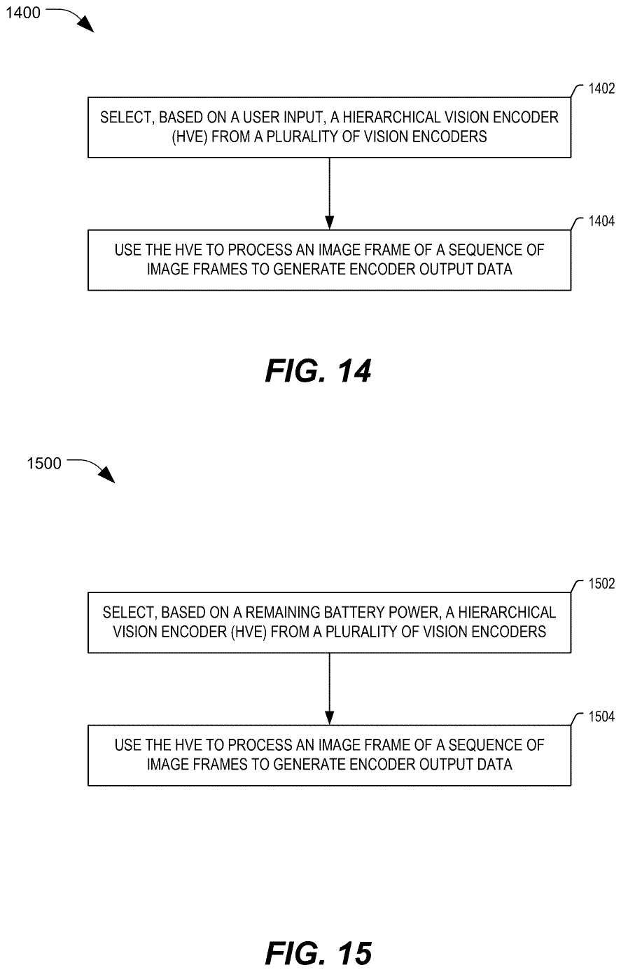

Referring to FIG. 14, a particular implementation of a method 1400 of conditional selection of a hierarchical vision encoder is shown. In a particular aspect, one or more operations of the method 1400 are performed by at least one of the encoder controller 150, the one or more processors 190, the device 102, the system 100 of FIG. 1A, the one or more components 540, the integrated circuit 502 of FIG. 5, or a combination thereof.

The method 1400 includes, at 1402, selecting, based on a user input, a hierarchical vision encoder (HVE) from a plurality of vision encoders. For example, the encoder controller 150 selects, based on the user input 172, the HVE 180 from the vision encoders 156, as described with reference to FIG. 1A.

The method 1400 includes, at 1404, using the HVE to process an image frame of a sequence of image frames to generate encoder output data. For example, the HVE 180 processes the image frame 112A of the sequence of image frames 112 to generate the encoder output data 128A, as described with reference to FIGS. 1A-1B.

A technical advantage of the method 1400 includes the ability to balance resource usage (e.g., size of neural network) with performance (e.g., visual richness in encoder output data) based on user input. For example, a first visual encoder that uses more resources and performs better can be dynamically selected when a user input indicating a preference for visual richness is detected. When another user input is detected, a second visual encoder that uses fewer resources can be dynamically selected.

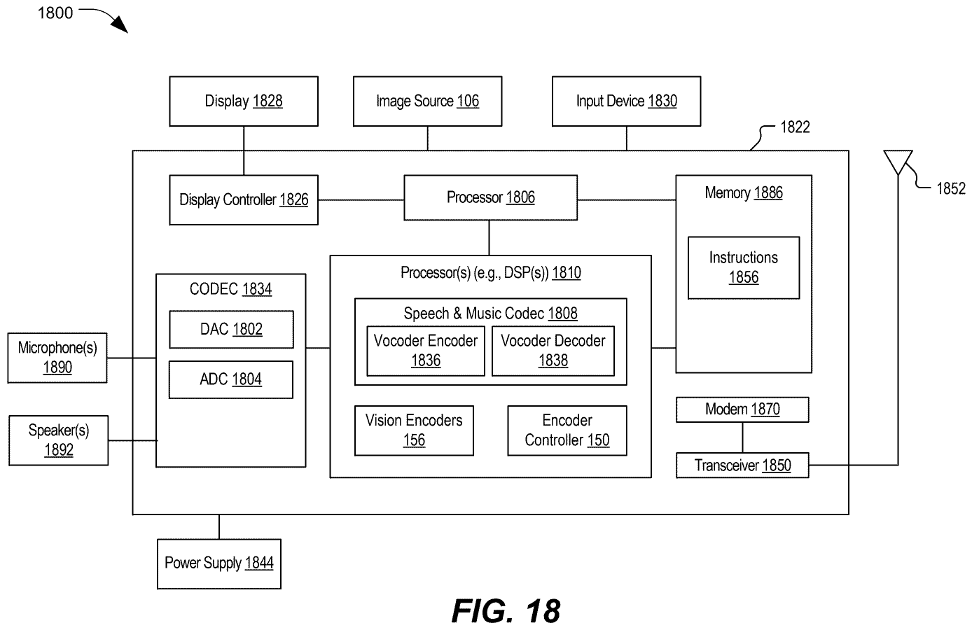

The method 1400 of FIG. 14 may be implemented by a FPGA device, an application-specific integrated circuit (ASIC), a processing unit such as a central processing unit (CPU), a digital signal processor (DSP), a controller, another hardware device, firmware device, or any combination thereof. As an example, the method 1400 of FIG. 14 may be performed by a processor that executes instructions, such as described with reference to FIG. 18.

Referring to FIG. 15, a particular implementation of a method 1500 of conditional selection of a hierarchical vision encoder is shown. In a particular aspect, one or more operations of the method 1500 are performed by at least one of the encoder controller 150, the one or more processors 190, the device 102, the system 100 of FIG. 1A) the system 200 of FIG. 2, the one or more components 540, the integrated circuit 502 of FIG. 5, or a combination thereof.

The method 1500 includes, at 1502, selecting, based on a remaining battery power, a hierarchical vision encoder (HVE) from a plurality of vision encoders. For example, the encoder controller 150 selects, based on the remaining battery power 276, the HVE 180 from the vision encoders 156, as described with reference to FIG. 2.

The method 1500 includes, at 1504, using the HVE to process an image frame of a sequence of image frames to generate encoder output data. For example, the HVE 180 processes the image frame 112A of the sequence of image frames 112 to generate the encoder output data 128A, as described with reference to FIGS. 1A and 1B.

A technical advantage of the method 1500 includes the ability to balance resource usage (e.g., size of neural network) with performance (e.g., visual richness in encoder output data) based on changing device conditions (e.g., battery power level). For example, a first visual encoder that uses more resources and performs better can be dynamically selected when higher resource usage conditions are detected (e.g., high remaining battery). As conditions change to lower resource usage conditions (e.g., lower remaining battery), a second visual encoder that uses fewer resources can be dynamically selected. If conditions change again (e.g., the battery is recharged), the first visual encoder or another visual encoder can be dynamically selected.

The method 1500 of FIG. 15 may be implemented by a FPGA device, an ASIC, a processing unit such as a CPU, a DSP, a controller, another hardware device, firmware device, or any combination thereof. As an example, the method 1500 of FIG. 15 may be performed by a processor that executes instructions, such as described with reference to FIG. 18.

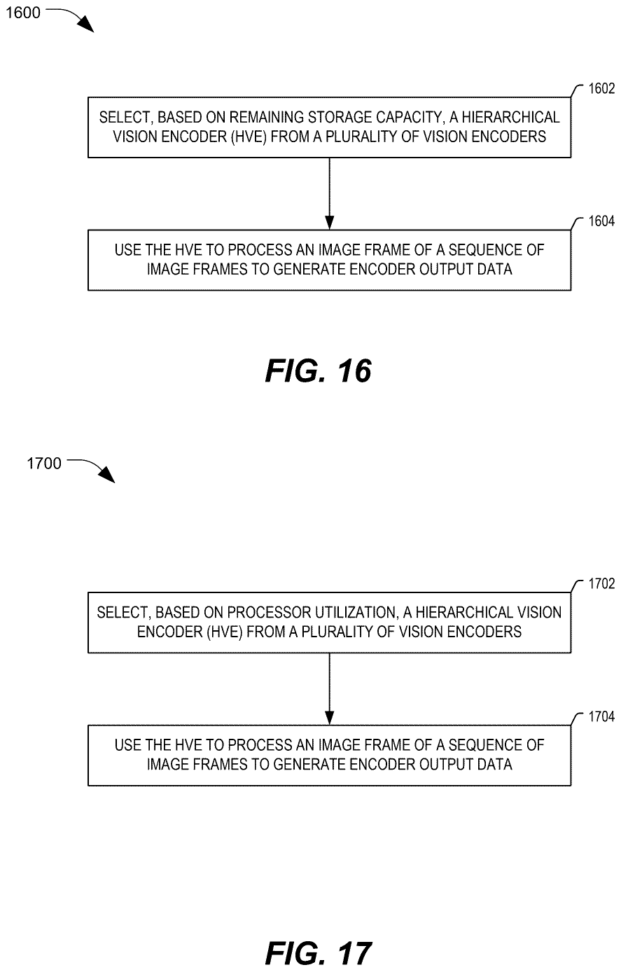

Referring to FIG. 16, a particular implementation of a method 1600 of conditional selection of a hierarchical vision encoder is shown. In a particular aspect, one or more operations of the method 1600 are performed by at least one of the encoder controller 150, the one or more processors 190, the device 102, the system 100 of FIG. 1A, the system 300 of FIG. 3, the one or more components 540, the integrated circuit 502 of FIG. 5, or a combination thereof.

The method 1600 includes, at 1602, selecting, based on remaining storage capacity, a hierarchical vision encoder (HVE) from a plurality of vision encoders. For example, the encoder controller 150 selects, based on the remaining storage capacity 376, the HVE 180 from the vision encoders 156, as described with reference to FIG. 3.

The method 1600 includes, at 1604, using the HVE to process an image frame of a sequence of image frames to generate encoder output data. For example, the HVE 180 processes the image frame 112A of the sequence of image frames 112 to generate the encoder output data 128A, as described with reference to FIGS. 1A and 1B.

A technical advantage of the method 1600 includes the ability to balance resource usage (e.g., size of neural network) with performance (e.g., visual richness in encoder output data) based on changing device conditions (e.g., storage capacity). For example, a first visual encoder that uses more resources and performs better can be dynamically selected when higher resource usage conditions are detected (e.g., high remaining storage capacity). As conditions change to lower resource usage conditions (e.g., lower storage capacity), a second visual encoder that uses fewer resources can be dynamically selected. If conditions change again (e.g., more storage capacity becomes available), the first visual encoder or another visual encoder can be dynamically selected.

The method 1600 of FIG. 16 may be implemented by a FPGA device, an ASIC, a processing unit such as a CPU, a DSP, a controller, another hardware device, firmware device, or any combination thereof. As an example, the method 1600 of FIG. 16 may be performed by a processor that executes instructions, such as described with reference to FIG. 18.

Referring to FIG. 17, a particular implementation of a method 1700 of conditional selection of a hierarchical vision encoder is shown. In a particular aspect, one or more operations of the method 1700 are performed by at least one of the encoder controller 150, the one or more processors 190, the device 102, the system 100 of FIG. 1, the system 400 of FIG. 4, the one or more components 540, the integrated circuit 502 of FIG. 5, or a combination thereof.

The method 1700 includes, at 1702, selecting, based on processor utilization, a hierarchical vision encoder (HVE) from a plurality of vision encoders. For example, the encoder controller 150 selects, based on the processor utilization 476, the HVE 180 from the vision encoders 156, as described with reference to FIG. 4.

The method 1700 includes, at 1704, using the HVE to process an image frame of a sequence of image frames to generate encoder output data. For example, the HVE 180 processes the image frame 112A of the sequence of image frames 112 to generate the encoder output data 128A, as described with reference to FIGS. 1A and 1B.

A technical advantage of the method 1700 includes the ability to balance resource usage (e.g., size of neural network) with performance (e.g., visual richness in encoder output data) based on changing device conditions (e.g., processor utilization level). For example, a first visual encoder that uses more resources and performs better can be dynamically selected when higher resource usage conditions are detected (e.g., low processor utilization). As conditions change to lower resource usage conditions (e.g., higher processor utilization), a second visual encoder that uses fewer resources can be dynamically selected. If conditions change again (e.g., lower processor utilization), the first visual encoder or another visual encoder can be dynamically selected.

The method 1700 of FIG. 17 may be implemented by a FPGA device, an ASIC, a processing unit such as a CPU, a DSP, a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102. In an illustrative implementation, the device 1800 may perform one or more operations described with reference to FIGS. 1A-17.

In a particular implementation, the device 1800 includes a processor 1806 (e.g., a CPU). The device 1800 may include one or more additional processors 1810 (e.g., one or more DSPs). In a particular aspect, the one or more processors 190 of FIG. 1, the one or more processors 590 of FIG. 5, or a combination thereof, correspond to the processor 1806, the processors 1810, or a combination thereof. The processors 1810 may include a speech and music coder-decoder (CODEC) 1808 that includes a voice coder (“vocoder”) encoder 1836, a vocoder decoder 1838, or both. The processors 1810 include the encoder controller 150, the vision encoders 156, or a combination thereof. Optionally, in some embodiments, the processors 1810 include the image source 106.

The device 1800 may include a memory 1886 and a CODEC 1834. The memory 1886 may include instructions 1856, that are executable by the one or more additional processors 1810 (or the processor 1806) to implement the functionality described with reference to the one or more components 540. The one or more components 540 include the encoder controller 150, the vision encoder 156, the image source 106, or a combination thereof, as described with reference to FIG. 5. The device 1800 may include a modem 1870 coupled, via a transceiver 1850, to an antenna 1852.

In a particular aspect, the modem 1870 is configured to transmit one or more sets of encoder output data 128. Optionally, in some embodiments, the modem 1870 is configured to receive the sequence of image frames 112 from the image source 106.

The device 1800 may include a display 1828 coupled to a display controller 1826. One or more speakers 1892, one or more microphones 1890, or a combination thereof may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the one or more microphones 1890, convert the analog signals to digital signals using the analog-to-digital converter 1804, and provide the digital signals to the speech and music codec 1808. The speech and music codec 1808 may process the digital signals. In a particular implementation, the speech and music codec 1808 may provide digital signals to the CODEC 1834. The CODEC 1834 may convert the digital signals to analog signals using the digital-to-analog converter 1802 and may provide the analog signals to the one or more speakers 1892.

In a particular implementation, the device 1800 may be included in a system-in-package or system-on-chip device 1822. In a particular implementation, the memory 1886, the processor 1806, the processors 1810, the display controller 1826, the CODEC 1834, and the modem 1870 are included in the system-in-package or system-on-chip device 1822. In a particular implementation, an input device 1830, a power supply 1844, and optionally the image source 106, are coupled to the system-in-package or the system-on-chip device 1822. Moreover, in a particular implementation, as illustrated in FIG. 18, the display 1828, the input device 1830, the one or more speakers 1892, the one or more microphones 1890, the antenna 1852, the power supply 1844, and optionally the image source 106, are external to the system-in-package or the system-on-chip device 1822. In a particular implementation, each of the display 1828, the input device 1830, the one or more speakers 1892, the one or more microphones 1890, the antenna 1852, the power supply 1844, and optionally the image source 106 may be coupled to a component of the system-in-package or the system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a car, a computing device, a communication device, an internet-of-things (IoT) device, a virtual reality (VR) device, an extended reality (XR) device, a base station, a mobile device, or any combination thereof.

In conjunction with the described implementations, an apparatus includes means for selecting, based on a user input, a hierarchical vision encoder (HVE) from a plurality of vision encoders. For example, the means for selecting can correspond to the encoder controller 150, the one or more processors 190, the device 102, the system 100 of FIG. 1A, the one or more components 540, the one or more processors 590, the integrated circuit 502 of FIG. 5, the processor 1806, the processor 1810, the device 1800 of FIG. 18, one or more other circuits or components configured to select an HVE 180 from the vision encoders 156, or any combination thereof.

The apparatus further includes means for using the HVE to process an image frame of a sequence of image frames to generate encoder output data. For example, the means for using the HVE can correspond to the vision encoders 156, the HVE(s) 180, the one or more processors 190, the device 102, the system 100 of FIG. 1A, the multi-context local attention(s) 160, the downscaling layer(s) 162, the stages 140 of FIG. 1B, the one or more components 540, the one or more processors 590, the integrated circuit 502 of FIG. 5, the processor 1806, the processor 1810, the device 1800 of FIG. 18, one or more other circuits or components configured to use an HVE 180 to process an image frame 112, or any combination thereof.

Also, in conjunction with the described implementations, an apparatus includes means for selecting, based on a remaining battery power, a hierarchical vision encoder (HVE) from a plurality of vision encoders. For example, the means for selecting can correspond to the encoder controller 150, the one or more processors 190, the device 102, the system 100 of FIG. 1A, the system 200 of FIG. 2, the one or more components 540, the one or more processors 590, the integrated circuit 502 of FIG. 5, the processor 1806, the processor 1810, the device 1800 of FIG. 18, one or more other circuits or components configured to select an HVE 180 from the vision encoders 156, or any combination thereof.

The apparatus further includes means for using the HVE to process an image frame of a sequence of image frames to generate encoder output data. For example, the means for using the HVE can correspond to the vision encoders 156, the HVE(s) 180, the one or more processors 190, the device 102, the system 100 of FIG. 1A, the multi-context local attention(s) 160, the downscaling layer(s) 162, the stages 140 of FIG. 1B, the system 200 of FIG. 2, the one or more components 540, the one or more processors 590, the integrated circuit 502 of FIG. 5, the processor 1806, the processor 1810, the device 1800 of FIG. 18, one or more other circuits or components configured to use an HVE 180 to process an image frame 112, or any combination thereof.

Also, in conjunction with the described implementations, an apparatus includes means for selecting, based on a remaining storage capacity, a hierarchical vision encoder (HVE) from a plurality of vision encoders. For example, the means for selecting can correspond to the encoder controller 150, the one or more processors 190, the device 102, the system 100 of FIG. 1A, the system 300 of FIG. 3, the one or more components 540, the one or more processors 590, the integrated circuit 502 of FIG. 5, the processor 1806, the processor 1810, the device 1800 of FIG. 18, one or more other circuits or components configured to select an HVE 180 from the vision encoders 156, or any combination thereof.

The apparatus further includes means for using the HVE to process an image frame of a sequence of image frames to generate encoder output data. For example, the means for using the HVE can correspond to the vision encoders 156, the HVE(s) 180, the one or more processors 190, the device 102, the system 100 of FIG. 1A, the multi-context local attention(s) 160, the downscaling layer(s) 162, the stages 140 of FIG. 1B, the system 300 of FIG. 3, the one or more components 540, the one or more processors 590, the integrated circuit 502 of FIG. 5, the processor 1806, the processor 1810, the device 1800 of FIG. 18, one or more other circuits or components configured to use an HVE 180 to process an image frame 112, or any combination thereof.

Also, in conjunction with the described implementations, an apparatus includes means for selecting, based on processor utilization, a hierarchical vision encoder (HVE) from a plurality of vision encoders. For example, the means for selecting can correspond to the encoder controller 150, the one or more processors 190, the device 102, the system 100 of FIG. 1A, the system 400 of FIG. 4, the one or more components 540, the one or more processors 590, the integrated circuit 502 of FIG. 5, the processor 1806, the processor 1810, the device 1800 of FIG. 18, one or more other circuits or components configured to select an HVE 180 from the vision encoders 156, or any combination thereof.

The apparatus further includes means for using the HVE to process an image frame of a sequence of image frames to generate encoder output data. For example, the means for using the HVE can correspond to the vision encoders 156, the HVE(s) 180, the one or more processors 190, the device 102, the system 100 of FIG. 1A, the multi-context local attention(s) 160, the downscaling layer(s) 162, the stages 140 of FIG. 1B, the system 300 of FIG. 3, the one or more components 540, the one or more processors 590, the integrated circuit 502 of FIG. 5, the processor 1806, the processor 1810, the device 1800 of FIG. 18, one or more other circuits or components configured to use an HVE 180 to process an image frame 112, or any combination thereof.

In some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to select, based on a user input (e.g., the user input 172), a hierarchical vision encoder (HVE) (e.g., the HVE 180) from a plurality of vision encoders (e.g., the vision encoders 156). The instructions further cause the one or more processors to use the HVE to process an image frame (e.g., the image frame 112A) of a sequence of image frames (e.g., the image frames 112) to generate encoder output data (e.g., the encoder output data 128A).

Also, in some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to select, based on a remaining battery power (e.g., the remaining battery power 276), a hierarchical vision encoder (HVE) (e.g., the HVE 180) from a plurality of vision encoders (e.g., the vision encoders 156). The instructions further cause the one or more processors to use the HVE to process an image frame (e.g., the image frame 112A) of a sequence of image frames (e.g., the image frames 112) to generate encoder output data (e.g., the encoder output data 128A).

Also, in some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to select, based on a remaining storage capacity (e.g., the remaining storage capacity 376), a hierarchical vision encoder (HVE) (e.g., the HVE 180) from a plurality of vision encoders (e.g., the vision encoders 156). The instructions further cause the one or more processors to use the HVE to process an image frame (e.g., the image frame 112A) of a sequence of image frames (e.g., the image frames 112) to generate encoder output data (e.g., the encoder output data 128A).

Also, in some implementations, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to select, based on processor utilization (e.g., the processor utilization 476), a hierarchical vision encoder (HVE) (e.g., the HVE 180) from a plurality of vision encoders (e.g., the vision encoders 156). The instructions further cause the one or more processors to use the HVE to process an image frame (e.g., the image frame 112A) of a sequence of image frames (e.g., the image frames 112) to generate encoder output data (e.g., the encoder output data 128A).

Particular aspects of the disclosure are described below in sets of interrelated Examples:

According to Example 1, a device includes a memory configured to store one or more sets of encoder output data; and one or more processors coupled to the memory and configured to select, based on a user input, a hierarchical vision encoder (HVE) from a plurality of vision encoders; and use the HVE to process an image frame of a sequence of image frames to generate encoder output data.

Example 2 includes the device of Example 1, wherein the plurality of vision encoders includes a first HVE associated with a first resource usage, and a second HVE associated with a second resource usage, wherein the user input is associated with a target resource usage, and wherein the one or more processors are configured to, based on determining that the first resource usage matches the target resource usage, select the first HVE as the HVE to be used to process the image frame.

Example 3 includes the device of Example 1 or Example 2, wherein the first HVE has a first count of parameters that is distinct from a second count of parameters of the second HVE.

Example 4 includes the device of any of Examples 1 to 3, and further includes a modem coupled to the one or more processors and configured to transmit the encoder output data.

Example 5 includes the device of any of Examples 1 to 4, and further includes a modem coupled to the one or more processors and configured to receive the sequence of image frames.

Example 6 includes the device of any of Examples 1 to 5, and further includes a camera coupled to the one or more processors and configured to generate the sequence of image frames.

Example 7 includes the device of any of Examples 1 to 6, wherein the memory and the one or more processors are integrated into a mobile device.

According to Example 8, a device includes a memory configured to store one or more sets of encoder output data; and one or more processors coupled to the memory and configured to select, based on a remaining battery power, a hierarchical vision encoder (HVE) from a plurality of vision encoders; and use the HVE to process an image frame of a sequence of image frames to generate encoder output data.

Example 9 includes the device of Example 8, wherein the plurality of vision encoders includes a first HVE associated with a first resource usage, and a second HVE associated with a second resource usage, wherein the remaining battery power is associated with a target resource usage, and wherein the one or more processors are configured to, based on determining that the first resource usage matches the target resource usage, select the first HVE as the HVE to be used to process the image frame.

Example 10 includes the device of Example 8 or Example 9, wherein the first HVE has a first count of parameters that is distinct from a second count of parameters of the second HVE.

Example 11 includes the device of any of Examples 8 to 10, and further includes a modem coupled to the one or more processors and configured to transmit the encoder output data.

Example 12 includes the device of any of Examples 8 to 11, and further includes a modem coupled to the one or more processors and configured to receive the sequence of image frames.

Example 13 includes the device of any of Examples 8 to 12, and further includes a camera coupled to the one or more processors and configured to generate the sequence of image frames.

Example 14 includes the device of any of Examples 8 to 13, wherein the memory and the one or more processors are integrated into a mobile device.

According to Example 15, a device includes a memory configured to store one or more sets of encoder output data; and one or more processors coupled to the memory and configured to select, based on remaining storage capacity, a hierarchical vision encoder (HVE) from a plurality of vision encoders; and use the HVE to process an image frame of a sequence of image frames to generate encoder output data.

Example 16 includes the device of Example 15, wherein the plurality of vision encoders includes a first HVE associated with a first resource usage, and a second HVE associated with a second resource usage, wherein the remaining storage capacity is associated with a target resource usage, and wherein the one or more processors are configured to, based on determining that the first resource usage matches the target resource usage, select the first HVE as the HVE to be used to process the image frame.

Example 17 includes the device of Example 15 or Example 16, wherein the first HVE has a first count of parameters that is distinct from a second count of parameters of the second HVE.

Example 18 includes the device of any of Examples 15 to 17, and further includes a modem coupled to the one or more processors and configured to transmit the encoder output data.

Example 19 includes the device of any of Examples 15 to 18, and further includes a modem coupled to the one or more processors and configured to receive the sequence of image frames.

Example 20 includes the device of any of Examples 15 to 19, and further includes a camera coupled to the one or more processors and configured to generate the sequence of image frames.

Example 21 includes the device of any of Examples 15 to 20, wherein the memory and the one or more processors are integrated into a mobile device.

According to Example 22, a device includes a memory configured to store one or more sets of encoder output data; and one or more processors coupled to the memory and configured to select, based on processor utilization, a hierarchical vision encoder (HVE) from a plurality of vision encoders; and use the HVE to process an image frame of a sequence of image frames to generate encoder output data.

Example 23 includes the device of Example 22, wherein the plurality of vision encoders includes a first HVE associated with a first resource usage, and a second HVE associated with a second resource usage, wherein the processor utilization is associated with a target resource usage, and wherein the one or more processors are configured to, based on determining that the first resource usage matches the target resource usage, select the first HVE as the HVE to be used to process the image frame.

Example 24 includes the device of Example 22 or Example 23, wherein the first HVE has a first count of parameters that is distinct from a second count of parameters of the second HVE.

Example 25 includes the device of any of Examples 22 to 24, and further includes a modem coupled to the one or more processors and configured to transmit the encoder output data.

Example 26 includes the device of any of Examples 22 to 25, and further includes a modem coupled to the one or more processors and configured to receive the sequence of image frames.

Example 27 includes the device of any of Examples 22 to 26, and further includes a camera coupled to the one or more processors and configured to generate the sequence of image frames.

Example 28 includes the device of any of Examples 22 to 27, wherein the memory and the one or more processors are integrated into a mobile device.

According to Example 29, a method includes selecting, based on a user input, a hierarchical vision encoder (HVE) from a plurality of vision encoders; and using the HVE to process an image frame of a sequence of image frames to generate encoder output data.

Example 30 includes the method of Example 29, further comprising, based on determining that a first resource usage matches a target resource usage, selecting a first HVE as the HVE to be used to process the image frame, wherein the plurality of vision encoders includes the first HVE associated with the first resource usage, and a second HVE associated with a second resource usage, and wherein the user input is associated with the target resource usage.

Example 31 includes the method of Example 29 or Example 30, wherein the first HVE has a first count of parameters that is distinct from a second count of parameters of the second HVE.

Example 32 includes the method of any of Examples 29 to 31 and further includes transmitting the encoder output data via a modem.

Example 33 includes the method of any of Examples 29 to 32 and further includes receiving the sequence of image frames via a modem.

Example 34 includes the method of any of Examples 29 to 33 and further includes receiving the sequence of image frames from a camera.

Example 35 includes the method of any of Examples 29 to 34, wherein the HVE is integrated into a mobile device.

According to Example 36, a method includes selecting, based on a remaining battery power, a hierarchical vision encoder (HVE) from a plurality of vision encoders; and using the HVE to process an image frame of a sequence of image frames to generate encoder output data.

Example 37 includes the method of Example 36, further comprising, based on determining that a first resource usage matches a target resource usage, selecting a first HVE as the HVE to be used to process the image frame, wherein the plurality of vision encoders includes the first HVE associated with the first resource usage, and a second HVE associated with a second resource usage, and wherein the remaining battery power is associated with the target resource usage.

Example 38 includes the method of Example 36 or Example 37, wherein the first HVE has a first count of parameters that is distinct from a second count of parameters of the second HVE.

Example 39 includes the method of any of Examples 36 to 38 and further includes transmitting the encoder output data via a modem.

Example 40 includes the method of any of Examples 36 to 39 and further includes receiving the sequence of image frames via a modem.

Example 41 includes the method of any of Examples 36 to 40 and further includes receiving the sequence of image frames from a camera.

Example 42 includes the method of any of Examples 36 to 41, wherein the HVE is integrated into a mobile device.

According to Example 43, a method includes selecting, based on remaining storage capacity, a hierarchical vision encoder (HVE) from a plurality of vision encoders; and using the HVE to process an image frame of a sequence of image frames to generate encoder output data.

Example 44 includes the method of Example 43, further comprising, based on determining that a first resource usage matches a target resource usage, selecting a first HVE as the HVE to be used to process the image frame, wherein the plurality of vision encoders includes the first HVE associated with the first resource usage, and a second HVE associated with a second resource usage, wherein the remaining storage capacity is associated with the target resource usage.

Example 45 includes the method of Example 43 or Example 44, wherein the first HVE has a first count of parameters that is distinct from a second count of parameters of the second HVE.

Example 46 includes the method of any of Examples 43 to 45 and further includes transmitting the encoder output data via a modem.

Example 47 includes the method of any of Examples 43 to 46 and further includes receiving the sequence of image frames via a modem.

Example 48 includes the method of any of Examples 43 to 47 and further includes receiving the sequence of image frames from a camera.

Example 49 includes the method of any of Examples 43 to 48, wherein the HVE is integrated into a mobile device.

According to Example 50, a method includes selecting, based on processor utilization, a hierarchical vision encoder (HVE) from a plurality of vision encoders; and using the HVE to process an image frame of a sequence of image frames to generate encoder output data.

Example 51 includes the method of Example 50, further comprising, based on determining that a first resource usage matches a target resource usage, selecting a first HVE as the HVE to be used to process the image frame, wherein the plurality of vision encoders includes the first HVE associated with the first resource usage, and a second HVE associated with a second resource usage, wherein the processor utilization is associated with the target resource usage.

Example 52 includes the method of Example 50 or Example 51, wherein the first HVE has a first count of parameters that is distinct from a second count of parameters of the second HVE.

Example 53 includes the method of any of Examples 50 to 52 and further includes transmitting the encoder output data via a modem.

Example 54 includes the method of any of Examples 50 to 53 and further includes receiving the sequence of image frames via a modem.

Example 55 includes the method of any of Examples 50 to 54 and further includes receiving the sequence of image frames from a camera.

Example 56 includes the method of any of Examples 50 to 55, wherein the HVE is integrated into a mobile device.

According to Example 57, a non-transitory computer-readable medium stores instructions that, when executed by one or more processors, cause the one or more processors to select, based on a user input, a hierarchical vision encoder (HVE) from a plurality of vision encoders; and use the HVE to process an image frame of a sequence of image frames to generate encoder output data.

Example 58 includes the non-transitory computer-readable medium of Example 57, wherein the instructions, when executed by the one or more processors, cause the one or more processors to, based on determining that a first resource usage matches a target resource usage, select a first HVE as the HVE to be used to process the image frame, wherein the plurality of vision encoders includes the first HVE associated with the first resource usage, and a second HVE associated with a second resource usage, and wherein the user input is associated with the target resource usage.

Example 59 includes the non-transitory computer-readable medium of Example 57 or Example 58, wherein the first HVE has a first count of parameters that is distinct from a second count of parameters of the second HVE.

Example 60 includes the non-transitory computer-readable medium of any of Examples 57 to 59, wherein the instructions, when executed by one or more processors, cause the one or more processors to initiate transmission of the encoder output data via a modem.

Example 61 includes the non-transitory computer-readable medium of any of Examples 57 to 60, wherein the instructions, when executed by one or more processors, cause the one or more processors to receive the sequence of image frames via a modem.

Example 62 includes the non-transitory computer-readable medium of any of Examples 57 to 61, wherein the instructions, when executed by one or more processors, cause the one or more processors to receive the sequence of image frames from a camera.

Example 63 includes the non-transitory computer-readable medium of any of Examples 57 to 62, wherein the HVE is integrated into a mobile device.

According to Example 64, a non-transitory computer-readable medium stores instructions that, when executed by one or more processors, cause the one or more processors to select, based on a remaining battery power, a hierarchical vision encoder (HVE) from a plurality of vision encoders; and use the HVE to process an image frame of a sequence of image frames to generate encoder output data.

Example 65 includes the non-transitory computer-readable medium of Example 64, wherein the instructions, when executed by the one or more processors, cause the one or more processors to, based on determining that a first resource usage matches a target resource usage, select a first HVE as the HVE to be used to process the image frame, wherein the plurality of vision encoders includes the first HVE associated with the first resource usage, and a second HVE associated with a second resource usage, and wherein the remaining battery power is associated with the target resource usage.

Example 66 includes the non-transitory computer-readable medium of Example 64 or Example 65, wherein the first HVE has a first count of parameters that is distinct from a second count of parameters of the second HVE.

Example 67 includes the non-transitory computer-readable medium of any of Examples 64 to 66, wherein the instructions, when executed by one or more processors, cause the one or more processors to initiate transmission of the encoder output data via a modem.

Example 68 includes the non-transitory computer-readable medium of any of Examples 64 to 67, wherein the instructions, when executed by one or more processors, cause the one or more processors to receive the sequence of image frames via a modem.

Example 69 includes the non-transitory computer-readable medium of any of Examples 64 to 68, wherein the instructions, when executed by one or more processors, cause the one or more processors to receive the sequence of image frames from a camera.

Example 70 includes the non-transitory computer-readable medium of any of Examples 64 to 69, wherein the HVE is integrated into a mobile device.

According to Example 71, a non-transitory computer-readable medium stores instructions that, when executed by one or more processors, cause the one or more processors to select, based on remaining storage capacity, a hierarchical vision encoder (HVE) from a plurality of vision encoders; and use the HVE to process an image frame of a sequence of image frames to generate encoder output data.

Example 72 includes the non-transitory computer-readable medium of Example 71, wherein the instructions, when executed by the one or more processors, cause the one or more processors to, based on determining that a first resource usage matches a target resource usage, select a first HVE as the HVE to be used to process the image frame, wherein the plurality of vision encoders includes the first HVE associated with the first resource usage, and a second HVE associated with a second resource usage, and wherein the remaining storage capacity is associated with the target resource usage.

Example 73 includes the non-transitory computer-readable medium of Example 71 or Example 72, wherein the first HVE has a first count of parameters that is distinct from a second count of parameters of the second HVE.

Example 74 includes the non-transitory computer-readable medium of any of Examples 71 to 73, wherein the instructions, when executed by one or more processors, cause the one or more processors to transmit the encoder output data via a modem.

Example 75 includes the non-transitory computer-readable medium of any of Examples 71 to 74, wherein the instructions, when executed by one or more processors, cause the one or more processors to receive the sequence of image frames via a modem.

Example 76 includes the non-transitory computer-readable medium of any of Examples 71 to 75, wherein the instructions, when executed by one or more processors, cause the one or more processors to receive the sequence of image frames from a camera.

Example 77 includes the non-transitory computer-readable medium of any of Examples 71 to 76, wherein the HVE is integrated into a mobile device.

According to Example 78, a non-transitory computer-readable medium storing instructions that, when executed by one or more processors, cause the one or more processors to select, based on processor utilization, a hierarchical vision encoder (HVE) from a plurality of vision encoders; and use the HVE to process an image frame of a sequence of image frames to generate encoder output data.

Example 79 includes the non-transitory computer-readable medium of Example 78, wherein the instructions, when executed by the one or more processors, cause the one or more processors to, based on determining that a first resource usage matches a target resource usage, select a first HVE as the HVE to be used to process the image frame, wherein the plurality of vision encoders includes the first HVE associated with the first resource usage, and a second HVE associated with a second resource usage, and wherein the processor utilization is associated with the target resource usage.

Example 80 includes the non-transitory computer-readable medium of Example 78 or Example 79, wherein the first HVE has a first count of parameters that is distinct from a second count of parameters of the second HVE.

Example 81 includes the non-transitory computer-readable medium of any of Examples 78 to 80, wherein the instructions, when executed by one or more processors, cause the one or more processors to transmit the encoder output data via a modem.

Example 82 includes the non-transitory computer-readable medium of any of Examples 78 to 81, wherein the instructions, when executed by one or more processors, cause the one or more processors to receive the sequence of image frames via a modem.

Example 83 includes the non-transitory computer-readable medium of any of Examples 78 to 82, wherein the instructions, when executed by one or more processors, cause the one or more processors to receive the sequence of image frames from a camera.

Example 84 includes the non-transitory computer-readable medium of any of Examples 78 to 83, wherein the HVE is integrated into a mobile device.

According to Example 85, an apparatus includes means for selecting, based on a user input, a hierarchical vision encoder (HVE) from a plurality of vision encoders; and means for using the HVE to process an image frame of a sequence of image frames to generate encoder output data.

Example 86 includes the apparatus of Example 85, further comprising means for selecting a first HVE as the HVE to be used to process the image frame, the first HVE selected based on determining that a first resource usage matches a target resource usage, wherein the plurality of vision encoders includes the first HVE associated with the first resource usage, and a second HVE associated with a second resource usage, and wherein the user input is associated with the target resource usage.

Example 87 includes the apparatus of Example 85 or Example 86, wherein the first HVE has a first count of parameters that is distinct from a second count of parameters of the second HVE.

Example 88 includes the apparatus of any of Examples 85 to 87 and further includes means to transmit the encoder output data via a modem.

Example 89 includes the apparatus of any of Examples 85 to 88 and further includes means to receive the sequence of image frames via a modem.

Example 90 includes the apparatus of any of Examples 85 to 89 and further includes means to receive the sequence of image frames from a camera.

Example 91 includes the apparatus of any of Examples 85 to 90, wherein the HVE is integrated into a mobile device.

According to Example 92, an apparatus includes means for selecting, based on a remaining battery power, a hierarchical vision encoder (HVE) from a plurality of vision encoders; and means for using the HVE to process an image frame of a sequence of image frames to generate encoder output data.

Example 93 includes the apparatus of Example 92, further comprising means for selecting a first HVE as the HVE to be used to process the image frame, the first HVE selected based on determining that a first resource usage matches a target resource usage, wherein the plurality of vision encoders includes the first HVE associated with the first resource usage, and a second HVE associated with a second resource usage, and wherein the remaining battery power is associated with the target resource usage.

Example 94 includes the apparatus of Example 92 or Example 93, wherein the first HVE has a first count of parameters that is distinct from a second count of parameters of the second HVE.

Example 95 includes the apparatus of any of Examples 92 to 94 and further includes means for transmitting the encoder output data via a modem.

Example 96 includes the apparatus of any of Examples 92 to 95 and further includes means for receiving the sequence of image frames via a modem.

Example 97 includes the apparatus of any of Examples 92 to 96 and further includes means for receiving the sequence of image frames from a camera.

Example 98 includes the apparatus of any of Examples 92 to 97, wherein the HVE is integrated into a mobile device.

According to Example 99, an apparatus includes means for selecting, based on remaining storage capacity, a hierarchical vision encoder (HVE) from a plurality of vision encoders; and means for using the HVE to process an image frame of a sequence of image frames to generate encoder output data.

Example 100 includes the apparatus of Example 99, further comprising means for selecting a first HVE as the HVE to be used to process the image frame, the first HVE selected based on determining that a first resource usage matches a target resource usage, wherein the plurality of vision encoders includes the first HVE associated with the first resource usage, and a second HVE associated with a second resource usage, and wherein the remaining storage capacity is associated with the target resource usage.

Example 101 includes the apparatus of Example 99 or Example 100, wherein the first HVE has a first count of parameters that is distinct from a second count of parameters of the second HVE.

Example 102 includes the apparatus of any of Examples 99 to 101 and further includes means for transmitting the encoder output data via a modem.

Example 103 includes the apparatus of any of Examples 99 to 102 and further includes means for receiving the sequence of image frames via a modem.

Example 104 includes the apparatus of any of Examples 99 to 103 and further includes means for receiving the sequence of image frames from a camera.

Example 105 includes the apparatus of any of Examples 99 to 104, wherein the HVE is integrated into a mobile device.

According to Example 106, an apparatus includes means for selecting, based on processor utilization, a hierarchical vision encoder (HVE) from a plurality of vision encoders; and means for using the HVE to process an image frame of a sequence of image frames to generate encoder output data.

Example 107 includes the apparatus of Example 106, further comprising means for selecting a first HVE as the HVE to be used to process the image frame, the first HVE selected based on determining that a first resource usage matches a target resource usage, wherein the plurality of vision encoders includes the first HVE associated with the first resource usage, and a second HVE associated with a second resource usage, and wherein the processor utilization is associated with the target resource usage.

Example 108 includes the apparatus of Example 106 or Example 107, wherein the first HVE has a first count of parameters that is distinct from a second count of parameters of the second HVE.

Example 109 includes the apparatus of any of Examples 106 to 108 and further includes means for transmitting the encoder output data via a modem.

Example 110 includes the apparatus of any of Examples 106 to 109 and further includes means for receiving the sequence of image frames via a modem.

Example 111 includes the apparatus of any of Examples 106 to 110 and further includes receiving the sequence of image frames from a camera.

Example 112 includes the apparatus of any of Examples 106 to 111, wherein the HVE is integrated into a mobile device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store one or more sets of encoder output data; and
one or more processors coupled to the memory and configured to:
select, based on a user input, a hierarchical vision encoder (HVE) from a plurality of vision encoders; and
use the HVE to process an image frame of a sequence of image frames to generate encoder output data.

2. The device of claim 1, wherein the plurality of vision encoders includes a first HVE associated with a first resource usage, and a second HVE associated with a second resource usage, wherein the user input is associated with a target resource usage, and wherein the one or more processors are configured to, based on determining that the first resource usage matches the target resource usage, select the first HVE as the HVE to be used to process the image frame.

3. The device of claim 2, wherein the first HVE has a first count of parameters that is distinct from a second count of parameters of the second HVE.

4. The device of claim 1, further comprising a modem coupled to the one or more processors and configured to transmit the encoder output data.

5. The device of claim 1, further comprising a modem coupled to the one or more processors and configured to receive the sequence of image frames.

6. The device of claim 1, further comprising a camera coupled to the one or more processors and configured to generate the sequence of image frames.

7. The device of claim 1, wherein the memory and the one or more processors are integrated into a mobile device.

8. A device comprising:
a memory configured to store one or more sets of encoder output data; and
one or more processors coupled to the memory and configured to:
select, based on a remaining battery power, a hierarchical vision encoder (HVE) from a plurality of vision encoders; and
use the HVE to process an image frame of a sequence of image frames to generate encoder output data.

9. The device of claim 8, wherein the plurality of vision encoders includes a first HVE associated with a first resource usage, and a second HVE associated with a second resource usage, wherein the remaining battery power is associated with a target resource usage, and wherein the one or more processors are configured to, based on determining that the first resource usage matches the target resource usage, select the first HVE as the HVE to be used to process the image frame.

10. The device of claim 9, wherein the first HVE has a first count of parameters that is distinct from a second count of parameters of the second HVE.

11. The device of claim 8, further comprising a modem coupled to the one or more processors and configured to transmit the encoder output data.

12. The device of claim 8, further comprising a modem coupled to the one or more processors and configured to receive the sequence of image frames.

13. The device of claim 8, further comprising a camera coupled to the one or more processors and configured to generate the sequence of image frames.

14. The device of claim 8, wherein the memory and the one or more processors are integrated into a mobile device.

15. A device comprising:
a memory configured to store one or more sets of encoder output data; and
one or more processors coupled to the memory and configured to:
select, based on remaining storage capacity, a hierarchical vision encoder (HVE) from a plurality of vision encoders; and
use the HVE to process an image frame of a sequence of image frames to generate encoder output data.

16. The device of claim 15, wherein the plurality of vision encoders includes a first HVE associated with a first resource usage, and a second HVE associated with a second resource usage, wherein the remaining storage capacity is associated with a target resource usage, and wherein the one or more processors are configured to, based on determining that the first resource usage matches the target resource usage, select the first HVE as the HVE to be used to process the image frame.

17. The device of claim 16, wherein the first HVE has a first count of parameters that is distinct from a second count of parameters of the second HVE.

18. The device of claim 15, further comprising a modem coupled to the one or more processors and configured to transmit the encoder output data.

19. The device of claim 15, further comprising a modem coupled to the one or more processors and configured to receive the sequence of image frames.

20. The device of claim 15, further comprising a camera coupled to the one or more processors and configured to generate the sequence of image frames.

21. The device of claim 15, wherein the memory and the one or more processors are integrated into a mobile device.

22. A device comprising:
a memory configured to store one or more sets of encoder output data; and
one or more processors coupled to the memory and configured to:
select, based on processor utilization, a hierarchical vision encoder (HVE) from a plurality of vision encoders; and
use the HVE to process an image frame of a sequence of image frames to generate encoder output data.

23. The device of claim 22, wherein the plurality of vision encoders includes a first HVE associated with a first resource usage, and a second HVE associated with a second resource usage, wherein the processor utilization is associated with a target resource usage, and wherein the one or more processors are configured to, based on determining that the first resource usage matches the target resource usage, select the first HVE as the HVE to be used to process the image frame.

24. The device of claim 23, wherein the first HVE has a first count of parameters that is distinct from a second count of parameters of the second HVE.

25. The device of claim 22, further comprising a modem coupled to the one or more processors and configured to transmit the encoder output data.

26. The device of claim 22, further comprising a modem coupled to the one or more processors and configured to receive the sequence of image frames.

27. The device of claim 22, further comprising a camera coupled to the one or more processors and configured to generate the sequence of image frames.

28. The device of claim 22, wherein the memory and the one or more processors are integrated into a mobile device.

29. The device of claim 22, wherein the one or more processors and the memory are integrated in a headset, a communication device, or both.

30. The device of claim 22, wherein the one or more processors are included in an integrated circuit.
